(19) United States
(12) Patent Application Publication
(10) Pub. No.: US 2018/0059005 A1
(43) Pub. Date: Mar. 1, 2018

(54) Microfluidic Methods and Apparatus for Analysis of Analyte Bearing Fluids

(71) Applicant: Redshift Bioanalytics, Inc., Burlington, MA (US)

(72) Inventors: Charles McAlister Marshall, North Andover, MA (US); Donald Kuehl, Windham, NH (US); Eugene Yi-Shan Ma, Newton, MA (US); Richard C. Sharp, Wayland, MA (US)

(21) Appl. No.: 15/605,962

(22) Filed: May 26, 2017

Related U.S. Application Data
(60) Provisional application No. 62/341,740, filed on May 26, 2016.

(51) Int. Cl. G01N 21/17; G01N 30/74; G01N 30/60; G01N 21/27; G01N 30/02

(52) U.S. Cl. CPC G01N 21/1717; G01N 30/74; G01N 2030/027; G01N 21/27; G01N 2021/1723; G01N 30/6095

(57) ABSTRACT

A fluid analyzer for analysis of analyte bearing fluids includes an optical source and an optical transducer defining a beam path of an optical beam; a fluid flow cell with a fluid channel, wherein an interrogation region is defined in which the optical beam interacts with the fluids resulting in transducer output signals; and a controller configured and operative to control operation of the fluid analyzer. In one example the fluid analyzer is controlled to (1) combine a third fluid with the first or second fluid, (2) conduct the first fluid and second fluid through the interrogation region in first and second intervals respectively, (3) measure the transducer output signals during the first and second time intervals, and (4) determine, from the transducer output signals measurement, values of the first and second fluids and an indication of a physical property of the first fluid.

### BACKGROUND

The present invention is related to the field of microfluidics.

### SUMMARY

Microfluidic methods and apparatus are disclosed for analysis of fluids and analyte bearing fluids. A disclosed fluid analyzer system includes an optical source and an optical transducer defining a beam path of an optical beam; a fluid flow cell with a fluid channel, wherein an interrogation region is defined in which the optical beam interacts with the fluids resulting in transducer output signals; and a controller configured and operative to control operation of the fluid analyzer. In one example embodiment, the fluid analyzer is controlled to (1) combine a third fluid with a first or second fluid to create a combined first and second fluid, (2) conduct the combined first fluid and second fluid through the interrogation region in a first interval and a second interval respectively, (3) measure the transducer output signals from the optical transducer during the first and second time intervals when the combined first fluid and second fluid reside in the fluid channel respectively, and (4) determine from the transducer output signals measurement values of the first and second fluids and an indication of a physical property of the first fluid. In other embodiments, alternative controller actions are performed. In other embodiments, a liquid chromatography detector is disclosed, as well as methods of operating a fluid analyzer.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is a schematic diagram of a microfluidic modulation spectroscopy (MMS) analyzer;

FIG. 2 is a schematic diagram of an MMS analyzer with heaters for temperature denaturation analysis;

FIG. 3 is a schematic diagram of a flow cell with fluidic mixers and multiple optical interrogation regions;

FIG. 4 is a schematic diagram of an MMS system employing electromagnetic modulation;

FIG. 5 is a flow diagram of a displacement measurement technique;

FIG. 6 is a schematic diagram of an MMS system used with an HPLC column;

FIG. 7A is a schematic diagram of an MMS system used with an HPLC column;

FIG. 7B is a plot of a detection output from an HPLC column;

FIG. 8 is a flow diagram of an HPLC measurement technique;

FIGS. 9-10 are schematic diagrams of flow cells;

FIG. 11 is a schematic diagram of a dual beam analyzer;

FIGS. 12-14 are schematic diagram describing introduction of sample into a fluid channel;

FIGS. 15-16 are schematic diagrams of a dual beam analyzer using a chopper;

FIG. 17 is a schematic diagram of a flow cell for analysis of two samples using two interrogation regions.

### DETAILED DESCRIPTION

Reference is made in this application to the language and disclosures of applications Ser. No. 14/673,015 (Fluid Analyzer with Modulation for Liquids and Gases) and Ser. No. 14/693,301 (Motion Modulation Fluidic Analyzer System). The specifications described therein refer to spectroscopic methods of optical measurement of modulated or moving fluids and is summarized generally herein as MMS or Microfluidic Modulation Spectroscopy.

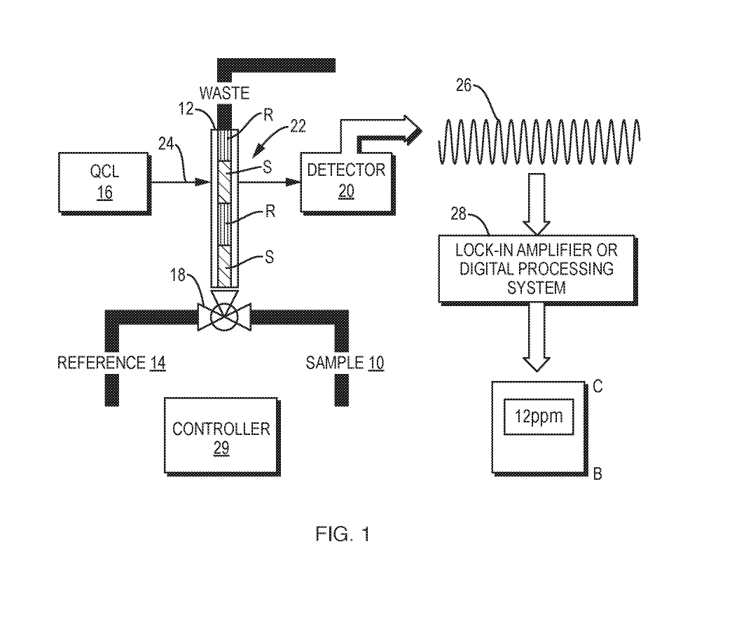

FIG. 1 shows an embodiment of an MMS system with serial streaming of sample and reference fluids through an optical interrogation region within a fluid cell.

In FIG. 1 a liquid sample solution 10 containing an analyte of interest is introduced into a fluid flow cell (or “flow cell”) 12 in either a continuous flowing stream, or in a flow-stop-measure-start-flow repeating sequence. In the flowing stream, a reference solution 14 (the order of sample and reference can be reversed) is introduced into the flow stream in such a manner as to create alternating segments or plugs in the flow stream of sample 10 and reference 14 materials. These alternating segments are shown as S for sample and R for reference. A Mid-IR source 16, such as a fixed frequency or tunable QCL laser 16 as shown, or one or more lasers, is tuned to a suitable wavelength for measuring the analyte(s) of interest, such as the peak of an absorbance feature chosen to minimize background interferences. The Mid-IR source 16 may be coupled to the fluid flow cell 12 through a fiber. The reference material is chosen as a suitable blank, such as pure solvent, a gas, or a suitable reference material or mixture representative of the sample background. The reference may be inserted into the sample stream using microfluidic techniques such as valves, mixers, pumps, or the use of pressure to alternate the sample and reference streams, all as known in the art. In the illustrated example a switching valve 18 is employed.

In this embodiment, the laser frequency (or equivalently, wavelength) is set to a value where the sample fluid has a differential absorbance relative to the reference fluid, and, in one embodiment, interferences (i.e. absorption from substances not of interest in the measurement) are minimal. Since the reference 14 has a different absorbance than the sample 10 at this frequency, the signal at a detector 20 is modulated as the sample and reference pass through the beam 24. The modulated waveform 26 produced by the detector may then be processed by a component 28 which may be a lock-in amplifier or a digital signal processing system to produce a value which is related to the analyte concentration. The fluid modulation waveform produced by a system controller 29 may control how the sample and reference solutions are introduced. For example, a rapid switching of the valve 18 interspersed with comparatively long periods of steady flow can create sharper boundaries between the sample and the reference with minimal mixing, resulting in a waveform that may be more square in form. Valves could also be controlled in such a manner as to create a mixing that blends the reference and sample solution in a smooth gradient, creating alternative waveforms, by way of example sinusoidal or triangular. Other waveforms could be created in this manner as well.

One important advantage is that the laser beam used to sample the cell 12 may be held motionless. Lasers, particularly CW lasers which can have higher signal to noise ratios than pulsed lasers, are prone to many optical effects in the presence of beam motion that can degrade performance. These include speckle, diffraction, feedback into the laser, mechanical repeatability, etc. If the laser beam is steered or translated alternatively between two sample cells or areas within the sample cell, performance can thereby be degraded.

Thus this embodiment allows a differential measurement or ratioing of background reference 14 and analyte sample 10 with no movement of the laser beam or change in wavelength of the laser source 16 or the detector 20.

The stream travels through the fluid flow cell 12, and the analyzer measures, continuously or intermittently, the transmission of both the sample and reference segments of the stream as they pass through an interrogation region 22 where the beam 24 meets the fluid flow cell 12. The calculation of the ratio of the absorbance of the sample and reference can be used determine the properties of the sample fluid and analyte of interest. Alternatively, the amplitude of the continuous modulation of the laser intensity at the detector 20 may be used to determine the concentration of the analyte. Similarly, as in wavelength modulation spectroscopy, detection schemes which take advantage of the higher orders of the modulation frequency (the rate at which the sample and reference pass through the cell) can be used to minimize the required frequency bandwidth thus rejecting noise and improving the sensitivity of the measurement.

The modulation waveform produced by the introduction of reference 14 in alternating segments would be a square wave if the sample 10 and reference 14 are discrete plugs with no mixing. One could also introduce the reference 14 into the sample stream 10 in a manner to achieve mixing in a controlled manner, to produce other modulation waveforms, such as may be achieved through variable control of the injection of the liquid. In one embodiment, the mixing is designed to achieve a sinusoidal modulation of the analyte concentration. Adjusting the modulation waveform may improve the performance of certain signal processing algorithms. Sampling of the waveform as measured by the detector 20 may include selecting a time interval during the fluid modulation of the reference and sample for sample integration such that the sampling duty cycle is less than 100%. The sampling time and location may be selected to provide the best measurement stability for purposes of co-adding the measurements to achieve better signal to noise and sensitivity. The sampling times for the reference 14 and sample 10 may not be the same in order to achieve a desired initial differential transmission value (e.g. 1). The timing of the sampling of reference 14 and sample 10 may be selected by analysis or measurement of the location of the boundary region between reference and sample. The timing of the sampling of reference 14 and sample 10 may be selected by analysis or measurement of the width of the boundary region between reference 14 and sample 10 (i.e. the width of the intermixing between reference and sample.

The detector 20 may be any suitable transducer for converting the optical signal to an electrical signal. By way of example, for a mid-IR source the detector may be a pyroelectric detector, a bolometer detector or a bandgap detector such as a HgCdTe photovoltaic. The optical signal may be coupled to the detector through a fiber.

To improve the modulation speed, the sample 10 and reference stream 14 could be rapidly pumped back and forth through the cell 12 rapidly, multiple times. This could be done using a pump, or by a piston type pump (not shown). In one embodiment, the channel of the transmission cell 12 may be longer than the diameter of the laser beam 24 and may contain multiple regions of sample 10 and reference 14 which are passed back and forth through the laser beam 24 by a piston. In this embodiment, the reference 14 and sample 10 may become mixed due, for example, to diffusion, dispersion, or turbulent mixing. In one embodiment, the number of passes may be limited by the diffusion rate such that the intermingled sample 10 and reference 14 are less than 50% of the size of the initial unmixed plug.

Alternatively, instead of a continuously flowing stream, rapidly filling the cell 12 alternately with the sample 10 and reference 14 streams, and performing the absorbance measurement while the sample/reference are in a static (non-flowing) state can be used. A variety of methods including switch valves can be used.

This method of sample modulation can be performed in a system for online continuous measurements, or the sample may be introduced into the system in “batch mode” whereby a static vessel is filled with the sample of interest, and the sample (and reference) is introduced into the cell from the vessel.

For the measurement process, multiple lasers may be used to simultaneously or sequentially measure multiple wavelengths for the purpose of measuring multiple analytes, or to measure sample interferences for the purpose of correcting and improving the accuracy of the measured analyte. One or more tunable lasers may be used to sequentially switch between multiple absorption lines, for the same purpose.

When measurements of emulsions, “dirty samples”, or samples that are likely to leave contaminating residue in the cell are made, it is possible to add a cleaner, which in one embodiment is optically non-interfering, to the reference and/or sample streams, such as a surfactant to remove hydrophobic materials such as fats or oils, or by adding an appropriate solvent. Alternatively, a cleaning solution may be periodically introduced into the cell to flush the system and clean the cell. The cleaning solution or another third background sample may have 100% transmission to provide a measurement of the total laser power, thereby calibrating the prior relative amplitude measurement into a more accurate and calibrated absolute measurement.

The disclosed technique allows for multiple analyte samples and reference samples to be introduced into the stream, the number of analyte samples and number of references being determined by the requirements of the measurement system.

Additionally, both multiple detectors 20 and multiple optical sources 16 can be used in the system to analyze multiple components simultaneously. In some instances, a single detector 20 can be used to simultaneously measure multiple wavelength sources which can be discriminated by an additional modulation of the source or sources, such as wavelength or amplitude modulations. Another embodiment uses multiple detectors 20 with a filter element in place for each detector 20 to selectively measure the desired source wavelength.

Those versed in the art of microfluidics will recognize that the intersection of microfluidic streams may also be used to generate slugs or packets of reference and sample fluid through the variation of pressure of the intersecting streams.

In another embodiment of an MMS system, parallel streaming or laminar flow parallel streaming of sample and reference fluids through an optical interrogation region within a fluid cell is used, where the sample and reference fluid flow side by side in the cell channel, with first one fluid and then other fluid moved into the interrogation region, all as described in Ser. No. 14/673,015 (Fluid Analyzer with Modulation for Liquids and Gases) and Ser. No. 14/693,301 (Motion Modulation Fluidic Analyzer System).

Measurement Techniques

A fluidic analyzer system may incorporate one or more the following embodiments and measurement techniques.

Protein Stability

Protein stability studies are critical in the development of protein based drug development (Biologics). These studies are used throughout the drug development process, from discovery through formulation, to select the most stable proteins candidates and formulations. Unstable biologic drugs will degrade and lose their efficacy and can create an immunogenic response which can be harmful or even deadly to the patient. Protein stability studies typically involve environmentally stressing the protein using temperature (heat or cold), changing the pH, adding chemical denaturants, illumination, or sheer or other mechanical agitation. By gradually increasing the level of stress, the protein can be monitored by various methods, and the point at which is becomes unstable or aggregates is determined. The more resistant the protein is to these stresses, the more likely it is to be stable and the more likely that the protein and/or its formulation will be a safe and effective product. In the development process, many different proteins and protein formulations candidates are tested in this fashion.

Current methods of protein stability testing can be a slow and tedious process. For thermal stress studies, differential scanning calorimetry (DSC) may be used. The technique involves heating the test sample and measuring the change in temperature of the sample. The amount of heat needed to change the sample temperature may be an indicator protein conformational change. This measurement is typically restricted to a narrow concentration range (typically 0.2-10 mg/mL) and at higher concentrations the protein sample may have to be diluted to perform the measurement. Since concentration can influence the protein's stability, dilution of the sample may lead to inaccurate results.

Chemical stability studies may involve creating a large number of samples with differing levels of denaturants or pH values, and then measuring the protein unfolding using detection techniques such as intrinsic and extrinsic fluorescence. The necessity of creating a large number of samples for measurement, in varying denaturant concentrations, is tedious and time consuming unless automated and leaves open the possibility of sample preparation errors which can lead to inaccurate or misleading results. All of the above approaches provide only a limited picture of the protein unfolding process. For example, DSC provides only limited information into the intermediate stages of unfolding. Extrinsic fluorescence requires the addition of a dye which binds to the protein which can influence the stability measurement and lead to inaccurate results. Intrinsic fluorescence requires the presence of a chromophore, such as tryptophan, in the protein, which not all proteins have. In addition, the fluorescence measurement is only sensitive to the local area of the protein in which the intrinsic or extrinsic label resides which limits the information.

In the sections below, a detailed description of a different approach to protein stability studies is provided which maintains distinct advantages over current methods. The same techniques may be applied to analytes other than proteins. Using a small volume microfluidic cell combined with an optical source such as a mid-IR laser for measuring protein stability allows for:
Rapid measurement of thermal stability due to the ability to rapidly heat the small volume significantly reducing measurement time;
Improved sensitivity and wide dynamic range of a mid-IR laser based measurement approach, allowing measurement over a large concentration range, thereby minimizing or eliminating the need for sample dilution and it associated complications;
Direct measurement of the protein, eliminating the need for chromophores to be present as is required in certain fluorescent measurements, thereby avoiding any chromophore-protein interaction effects to the protein structure;
Obtaining information on the protein structure and quantitative sub-structure (secondary structure) motifs;
Microfluidic introduction of buffers and denaturants in a continuous manner to accelerate the measurement time, reduce sample preparation errors, and minimize sample volume;
Tuning the light source (e.g. laser) to a select subset of wavelengths to improve the sensitivity and specificity of the measurements and to reduce measurement time.

Continuous Flow Microfluidic Thermal Denaturation

Current thermal or chemical denaturation studies of proteins (or other analytes) aim to estimate protein stability by correlating the amplitude of an external stressor (such as temperature or pH) to the amount of fractional change in protein structure. For thermal stability studies, typically the sample temperature is gradually increased to allow the sample and its holding device (e.g. a fluidic cell or cuvette) to come to thermal equilibrium before a structure probing measurement(s) are made (e.g. by circular dichroism, fluorescence, FTIR). This gradual thermal technique may be due to the large thermal mass of the sampling device, a large sample volume (e.g. 100's of ul) of the sample, or the desire to allow longer dwell times at each temperature (for example in proteins, to allow time for conformational changes to materialize). Similarly, for chemical denaturation, mixing of the sample must be completed and the protein measurement taken before proceeding to the next chemical denaturant sample.

An alternative approach and an embodiment of the invention uses a fluid flow system incorporating a microfluidic measurement cell as described in the referenced applications. The technique may also be applied when using other embodiments for measurement in this specification.

In one embodiment, the controller is configured and operative to control operation of the fluid analyzer to (1) change a temperature of the first fluid from a first temperature to a second temperature, (2) conduct the first fluid and second fluid through the interrogation region in first and second intervals respectively, (3) measure the transducer output signals from the optical transducer during the first and second time intervals when the first fluid and second fluid reside in the fluid channel, and (4) determine from the transducer output signals measurement values of the first and second fluids and an indication of a physical property of the analyte.

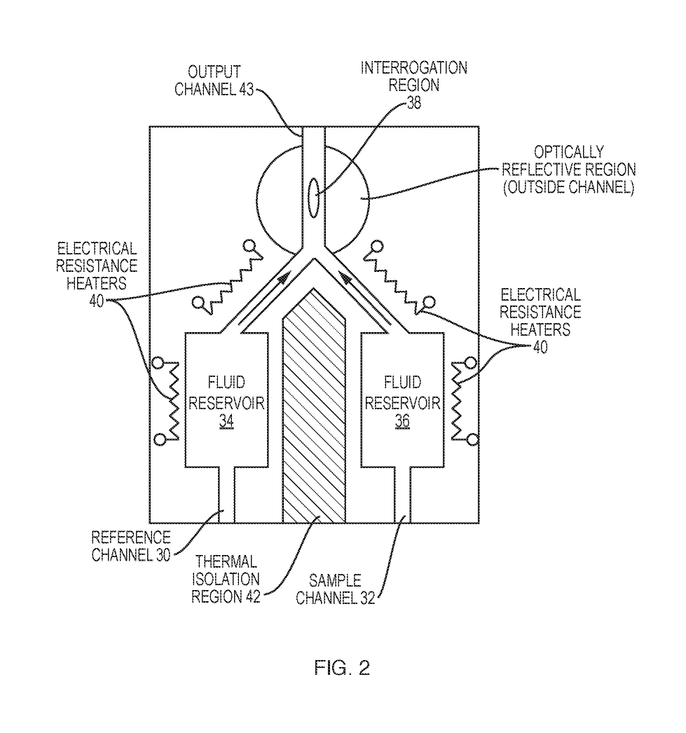

FIG. 2 shows an embodiment of the fluid cell for such operation. The cell can be an optical measurement cell for probing the protein characteristics, although the technique is not limited to optical measurements. The cell fluid may enable static measurement or may include channels 30, 32 for conducting one or more fluids through the device, including regions where fluids are combined into a single stream to create parallel laminar flow, mixed flow, or serial “slug flow” of the liquids. The cell may include reservoirs 34, 36 for “holding fluids” prior to entering the interrogation region 38 of the cell, or a reservoir may be external to the cell and used to supply fluids to the cell. Multiple reservoirs may be used to provide “staging” of the fluids at different temperatures or other conditions (e.g. with different denaturants or buffers), and flow rates, channel dimensions or reservoir volumes may be used to determine fluid effective dwell times within a reservoir. A long channel length may also be used as an effective reservoir. Channel fluidic impedance may vary in different regions of the cell in order to change fluid velocity and effective fluid dwell times in different regions of the cell at a constant inlet pressure.

The cell may be formed in a variety of materials as known in the art, such as silicon fabricated using MEMS techniques or in a polymer using molds. Silicon has a relatively high thermal conductivity and can be used to reduce thermal gradients across areas of the cell which are designed for thermal equilibration. Glasses and polymers have lower thermal conductivity and may be advantageous in creating regions across the cell with difference temperatures or temperature gradients, or in creating or maintaining a temperature difference between the cell and fluids in the cell.

The cell may include one or more embedded or surface heaters 40 and regions of higher and lower thermal conductivity or thermal isolation regions in order to change and control the temperature of one or more fluids contained in channels or reservoirs within the cell. Thermal isolation 42 may be achieved through the removal of cell material during manufacture, as is known in the art for creating thermal isolation regions (for example by removal or etching of silicon), or through design of a mold for molded materials. A cell may be made of different materials in order to provide regions of greater and lesser thermal conductivity. The cell may also be mounted to an assembly that controls the temperature of the entire cell, or sections of the cell, in order to heat or cool the cell relative to, for example, ambient temperature. One or more thermoelectric coolers may be used for this purpose.

One embodiment of the cell may include two inlet channels 30, 32 for reference and sample respectively, and an outlet channel containing an interrogation region 38. The fluidic channel regions may be defined by a material sandwiched between two windows, and the sandwiched material may be highly reflective (e.g. >99%) at the wavelengths of an interrogation optical beam. The fluidic flow channels or interrogation region may be defined in part or entirely by a highly reflective or highly absorptive material deposited on one or more of the surfaces of the microfluidic cell, the surface being either an external surface or an interior surface (i.e. a metal film deposited on one side of a silicon surface which may also include etched channels for conducting fluid in the cell as known in the art). The sandwiched, reflective or absorptive material may define an interrogation region that is smaller than the flow dimensions of the microfluidic channel in either the direction of fluidic flow, orthogonal to the direction of flow or both. The interrogation region may be smaller than the width of the fluidic channel such that the interrogation region does not substantially sample the no-slip regions on the sides of the channels in direction orthogonal to the direction of propagation of the optical beam. A feedback loop may be used to control the size or position of the interrogation region relative to the fluidic channel physical geometry, or fluidic junctions, the feedback loop including a measurement of, or the known value of, the fluid viscosity or the contrast ratio between sample and reference. A feedback loop or calibration loop may be used to control the fluidic modulation rate, or the amount of time or fluid volume that passes through the cell between consecutive measurements of different sample fluids.

For thermal denaturation studies, in one embodiment the sample, or sample and reference fluids, may be first held in a reservoir or reservoirs at a fixed temperature typically not higher than the lowest temperature to be probed for denaturation. The microfluidic cell, or portions of the cell containing a fluid, are designed to equilibrate rapidly with a temperature change (i.e. induced by electrical heater or Peltier thermo-electrical control, build into the cell or in thermal contact with the cell). The sample may be continuously flowed through the measurement cell. Due to the small fluidic volume within the cell and/or the cell channels (typically in the sub-microliter or microliter range), as the sample and reference fluids travel through the channels within the cell, or heated region of the cell if the entire cell is not heated equally, the fluids come to thermal equilibrium with the cell temperature (models may show millisecond time scale). As such, the interrogation measurement can be made as soon as the sample and reference fluids reach the optical interrogation region in the cell, eliminating the need to wait for thermal equilibration as in a traditional system using larger volume cells or plate wells. In one embodiment, the sample and reference fluids are at the same temperature during the MMS measurement at a given sample temperature. In another embodiment, the sample and reference through the use of different heating elements or flow channels, different sample and reference fluid temperatures may be realized. In addition, the measurement cell and thermal control system can be optimized for equilibrating rapidly to induced temperature changes, and hence rapid and accurate temperature control of the sample in the cell can be achieved. As such, a complete thermal study of the material may be done by rapidly ramping the temperature of the cell, accelerating the time of measurement.

For example, the cell temperature may be ramped, the liquids may move through the cell in a flowing stream, and the optical sample measurements can be made in a continuous manner to generate a sequence of stability measurements over temperature at one or more optical wavelengths of interest. Furthermore, the length of time the sample is exposed to the temperature can be accurately controlled by adjusting either the flow rate of the system, or by adjusting the length of the channel (or additional tubing) or reservoirs that are under temperature control before reaching the cell optical measurement position, or by the use of stop flow methods. This further allows another dimension to be studied in the sample, the reaction rate for the particular sample to the thermal change. The reaction rate may be on the order of 10's of milliseconds or longer. Localized heating within the cell or within the fluid channel may also be used to change temperature at faster rates.

In one embodiment, a temperature gradient may exist in a liquid stream between the interrogation region 38 and fluid containing input reservoir 34. The stream may flow continuously during the measurement, may be stopped during the measurement, or certain parts of the measurement (i.e. at certain wavelengths of absorption measurement), or be stopped between measurements and flowing during the optical measurement. The flow rate of the liquid or velocity of the liquid through the interrogation region may be changed in order to change the amount of time that the liquid is exposed to a certain temperature of interest. The width of a microfluidic channel may be changed to change the flow rate through an interrogation region. Multiple interrogation regions may be built into a cell, either for measurement in parallel (i.e. a multiplicity of FIG. 2 in a single cell) or multiple interrogation regions may be serially placed in the outlet channel 43, each interrogation region designed to measure the fluid at a different temperature or at different amount of time that the liquid is exposed to a desire temperature. Each successive interrogation region may have a different channel dimension (width, length or depth in the direction of interrogation resulting in variations in fluid velocity between or within interrogations regions). The interrogation region may be moved relative to the cell by mechanical motion of the cell relative to the optical beam. The optical beam may be split into more than one beam, each of the split beams being incident on a different interrogation region. The split beams may be combined on a single detector after passing through the interrogation regions, each of the beams being time multiplexed onto the detector through a mechanical means of blocking all but one of the split beams, through use of different optical modulation frequencies at each interrogation region with subsequent separation in signal processing as known in the art.

Using an MMS cell, a mid-IR laser may be tuned to one or more wavelengths of light that probe a given property of the sample fluid. For example, detection of the amount of change in a protein's alpha helical content as measured at a single optical wavelength may be directly indicative of the amount of denaturation in that sample and a measure of the protein stability. Other wavelengths may be monitored to look at different chemistries in the denaturation of a protein or other analyte. This can be done by incorporating multiple single wavelength lasers (measuring simultaneously or consecutively with one or more optical detectors), or by using a tunable light source. A tunable laser may be fixed at a single wavelength to perform a thermal study over temperature and then tuned to a different wavelength and the thermal scan repeated for the same sample type to develop a composite spectrum. In some cases, this approach can be more time-efficient than an alternative approach of spectrally scanning the tunable laser over multiple wavelengths of interest at one sample temperature, then repeating the spectral scan at another temperature.

More generally, the system in operation may perform the following steps (1) operate a laser or other optical source at one wavelength while an analyte fluidic environment (temperature, PH, buffer chemistry, etc.) is changed over time (examples include, but are not limited to: a change in sample temperature or the introduction of a denaturant), (2) optically measure and detect a change in the analyte fluid and an analyte characteristic, (3) in response to the change in the analyte characteristic, operate the optical source at multiple wavelengths, (4) detect and measure additional optical characteristics of the analyte fluid and analyte.

More specifically, a method of measuring an analyte in a fluid with an analyzer includes performing a first spectroscopic characterization including (i) directing a first set of one or more wavelengths to an interrogation region of the fluid, (ii) changing an environmental condition of the analyte, (iii) measuring a first optical characteristic of the analyte bearing fluid, and (iv) calculating a first physical characteristic of the analyte from the first optical characteristic. The method further includes analyzing the first physical characteristic to select a second set of one more wavelengths for a second spectroscopic characterization, at least one wavelength in the second set being different than in the first set. The method further includes performing the second spectroscopic characterization including (i) directing the second set of wavelengths to the interrogation region of the fluid, (ii) measuring a second optical characteristic of the analyte bearing fluid, and (iii) calculating a second physical characteristic of the analyte from the second optical characteristic. The flow rate may be changed, or fluid flow stopped between the first and second determination or during the second determination of the physical characteristic relative to the first determination. In this manner the desired number of wavelengths can be determined as a dynamic function of the sample under testing, thereby optimizing test parameters such as measurement time and sample fluid volume.

In one embodiment, calibration or referencing may be performed during the ramping temperature and may include conducting a fluid into the interrogation region during a time interval normally used for measurement of the sample or reference fluids. This fluid may be the sample fluid, the reference fluid or a third fluid different from the reference and sample fluid. Fluid flow and MMS fluid modulation may be stopped during the portions of the temperature ramping, and the rate of fluid modulation or other operating conditions of the analyzer may be changed as a function of changes in the sample fluid or reference fluid properties over temperature. In one embodiment, the sample viscosity may increase with temperature, and a feedback loop or calibration loop may be used to control the fluidic modulation rate or a pressure reduced to control fluid velocity in the interrogation region.

The temperature ramp may be bidirectional, and measurements may be performed both as the fluid temperature ramps to higher temperatures and then as the temperature is ramped back down in temperature. The analyzer controller may store in memory certain operating conditions and fluid properties determined during one part of the temperature ramp for use in a different part of the temperature ramp.

In a system in which the temperature of the sample is continuously ramped at the optical interrogation region and absorption (or other physical properties of the sample) are measured at multiple wavelengths with a single tunable laser, the laser tuning rate and rate of temperature ramp may be synchronous in that the temperature change between subsequent measurements at a certain wavelength are nominally the same for each of the wavelengths (i.e. as the temperature is ramped from 50 C to 100 C, the measurements at wavelength A are spaced at 5 C increments (e.g. 55, 60, 65 C) and measurements at wavelength B may also be spaced at 5 C but out of phase (e.g. 56, 61, 66 C). More complex scenarios may also be used, such as maintaining one fixed interval for wavelength A (i.e. every 1 C) and a different temperature interval for one or more additional wavelengths which may be used less or more frequently in the measurement. In this manner, the system may efficiently provide information about the processes induced by the thermal (or as disclosed in other embodiments chemical) changes.

In one embodiment, the sample fluid in the exit stream may be looped back into the fluidic cell input in order to reduce the amount of sample fluid used in an MMS sample. The temperature of the fluid looped back may be changed, thus generating a thermal ramp where each successive lop back is at a different (higher or lower) temperature. Each loop back may also be at successively greater dilution than the preceding loop back. Alternatively, using laminar flow and microfluidic fluid separation or fraction collection techniques as known in the art, the level of dilution may be reduced or substantively eliminated.

In many measurements (e.g. protein denaturation studies), typically only gross or total change in characteristics (i.e. protein unfolding) is measured as a function of environmental condition or time (e.g. with DSC calorimetry, fluorescence). Therefore, for spectral characterization of total changes in protein structure, in one embodiment a single or even few discrete wavelengths may be sufficient. For example, one could probe the wavelength for alpha-helical structures (1656 cm−1), tracking optical absorbance which typically decreases with protein unfolding. Spectral measurement at fewer wavelengths can be accomplished more quickly and more efficiently due to the overhead of wavelength switching times. One can selectively choose what structure to monitor, but the user can also choose to monitor multiple structure(s) of interest with one or more wavelengths (more information, additional characterization).

In another embodiment, when characterizing proteins within a buffer solution, the change in beta or helical peak absorption wavelengths may be used to determine when to measure absorption at other protein structure motifs, such as ant-parallel beta sheets as an indicator of protein aggregation.

Continuous Flow Microfluidic Chemical Denaturation

In another embodiment, the fluid analyzer may be used to study or monitor the progress of a chemical reaction or other dynamic process. As the fluid analyzer may be a continuous flow system, it may be used to continuously sample a chemical reaction to provide real-time feedback to optimize the reaction process and determine the reactions optimum end point. This is in contrast to other optical methods for monitoring which require in-line probes or more traditional methods or static sampling probes.

Chemical denaturation studies may also be performed in such a microfluidic analyzer system. In conventional chemical denaturation studies the sample containing an analyte (e.g. protein) and chemical denaturant concentration is varied discretely in sample containers, such as the well containers in a standard 96 well plate. This conventional method may be interfaced to the microfluidic sampling cell using conventional sample handling systems (robots, auto-samplers, sippers, etc.) In addition, thermal studies may be performed in the microfluidic cell for each concentration of chemical denaturant. The analyte may also be contained in different formulation buffers, each with a different compounds or concentrations to ensure a stable product. These compounds may include solubilizers, stabilizers, buffers, tonicity modifiers, bulking agents, viscosity modifiers, surfactants, chelating agents, and adjuvants. Thus, testing formulations may involve a complex array of experimental samples, each with a different mix of buffer solution and denaturant.

In this respect, the system controller may be configured and operative to control operation of the fluid analyzer to (1) combine a third fluid with the first or second fluid, (2) conduct the first fluid and second fluid through the interrogation region in a first interval and a second interval respectively, (3) measure the transducer output signals from the optical transducer during the first and second time intervals when the first fluid and second fluid reside in the fluid channel, and (4) determine from the transducer output signals measurement values of the first and second fluids and an indication of a physical property of the first fluid.

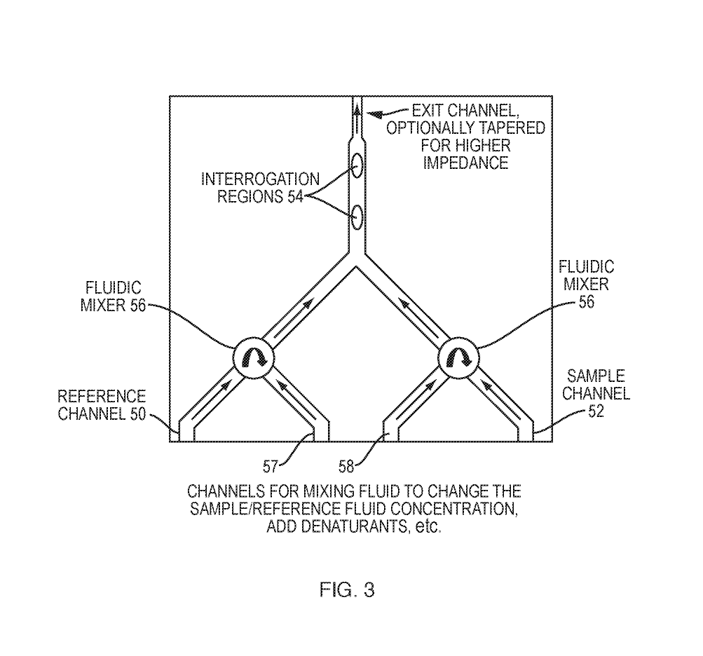

FIG. 3 illustrates a fluidic analyzer of this type of embodiment, in which the chemical denaturant may be introduced through one or both channels 57, 58 into the flowing system in one channel or both channels 50, 52 and optionally directly on the microfluidic device, which may have multiple interrogation regions 54 along with respective mixers 56 and fluidic channels. Channels 57 and 58 may also be used to introduce two different fluids. Turbulent fluidic mixing may be done on the device using microfluidic techniques as well known to those versed in the art, and the mixed sample is then flowed through the interrogation region in a serial or parallel flow manner as described in the referenced prior applications. This allows the chemical denaturant to be created and controlled dynamically, making possible both discrete measurements of, for example, a particular concentration of denaturant in the sample, or the sampling of a stream of sample fluid with a continuously varying denaturant concentration (i.e. as would be obtained by the continuous introduction of an increasing concentration of denaturant into the stream). The fluid flow may be stopped for a period of time to allow more thorough fluid mixing or to enable certain chemical reactions to occur prior to measurement in the interrogation region.

As mentioned previously, thermal denaturation may also be incorporated into the study as yet another dimension for studying the samples, such as in studying the thermal stability of a protein as function of denaturant concentration. Thus in one embodiment, the stability measurement is isothermal, for example a sequence of chemical denaturant measurements is taken at a constant temperature. In another embodiment, fluidic temperature may be varied within one or more of the denaturant sequence measurements.

The same mixing system can also be used to vary sample concentration (i.e. protein concentration in the sample), another variable known to have an effect on the sample chemistry. For example, channels 50 and 52 may contain a buffer solution and a variable amount of protein may be introduced using channel 58. Simultaneously, channel 57 may not be used, or channel 57 may introduce an additional fluid type, which may also include an additional analyte to be comparatively measured against the analyte of channel 58. More than one set of fluidic mixing assemblies as shown in FIG. 3 may be included in the analyzer in order to reduced testing time through parallel operation and measurement.

In one embodiment, the analyzer may be operated to study kinetics or the rate of chemical interaction of fluids and analytes. The dwell time (i.e. the time between the first combination of fluids in channels 50 and 57 (or 52 and 58) and measurement in the interrogation region may be varied between the reference and sample channel. The reference and sample channels may have the same fluids, and the analyzer may be operated to look at the difference in fluids in the interrogation region as a function of the difference in dwell times between the two channels. In this manner the analyzer functions as fluidic comparator. Similarly, the fluids combined with the sample channel 52 and reference channel 50 through mixing channels 57 and 58 may be different, and the sample channel 52 and reference channel 52 may contain the same analyte bearing fluid. It should be clear that various combinations of fluids and time delays may be used to evaluate fluids, analyte bearing fluids, and the interaction of fluids over time.

Additionally, the width of the exit channel may be wider or narrower after the interrogation region than the width of the channel at the interrogation region. A narrower region may be used to increase fluidic impedance while providing for a larger area interrogation region.

Such a system may be entirely automated and programmable through computer control, allowing for sample analysis under a large number of conditions rapidly and with automation. In addition, the system may be programmed to recognize trends in the experimental measurements and dynamically change the measurement sequence to better understand the sample chemistry. Control of the various streams may be enable by such techniques described in the referenced applications or as known in the art, included the use of backing pressure and flow control valves.

Those versed in the art will recognize that the various techniques for controlling dwell times, reservoirs, channel dimensions, calibration, modulation, feedback, loops, etc. that were described for the thermal analyzer embodiments can also be applied for chemical analyzer embodiments. Different measurement probes (e.g. IR, UV, Fluorescence, electrochemical, physical properties) may be incorporated in the measurement cell either simultaneously or serially to provide additional chemical or physical information about the sample.

Fluidic and Spectral Modulation As modulation can improve the sensitivity and stability as described previously, other novel ways to modulate a system comprised of a transducer system and a microfluidic cell can be invoked for the measurement of fluids.

One type of modulation in that is used in gas phase spectroscopy is wavelength modulation spectroscopy whereby the frequency of the laser is modulated by a small amount to enable the measurement the slope of the absorption band in either a continuous scanning mode or at discrete wavelengths. This can improve signal to noise and eliminate measurement errors due to low frequency drift of the laser power, detector systems, optics, and electronics.

An alternative to modulating the fluid type (i.e. sample and reference) to improve performance is to modulate a physical property of a fluid. Many different physical properties may be modulated including concentration of an analyte in the fluid but also characteristics such as reflectivity, particle location, temperature, analyte type, and liquid type. In one embodiment, an electromagnetic(e.g. an electric field) field may modulate the charged particles of the protein or other substance present in the fluid as described in detail below to provide a time variable signal detectable through MMS detection techniques (i.e. the reference and sample fluids now become a sample fluid which varies between analyte and no-analyte, or full and partial analyte concentration, or some other changeable physical property measured through modulation spectroscopy). Electromagnetic fields, flash heating, and optical illumination are all techniques that can be used to create modulation of a physical characteristic of the fluid in the cell that can then be measured in a differential manner to determine physical characteristic of a fluid or an analyte in a fluid.

Electrophoresis is a well-known technique commonly used for the separation of biological molecules such as proteins and nucleic acids. The principle is based on the movement of charged molecules or particles (sample) in solution in the presence of an electric field.

This same principle can be used to modulate the sample or sample concentration in a liquid across an optical beam to perform a differential measurement of the sample. Thus in one embodiment the analyzer includes an electromagnetic fluid modulator for changing a characteristic of the fluid between a first time interval and a second time interval at the interrogation region. The controller is configured and operative to (1) control the fluid modulator, (2) measure the transducer output signals from the optical transducer during the first and second time intervals, and (3) determine from the transducer output signals a measurement value indicative of a physical property of the analyte.

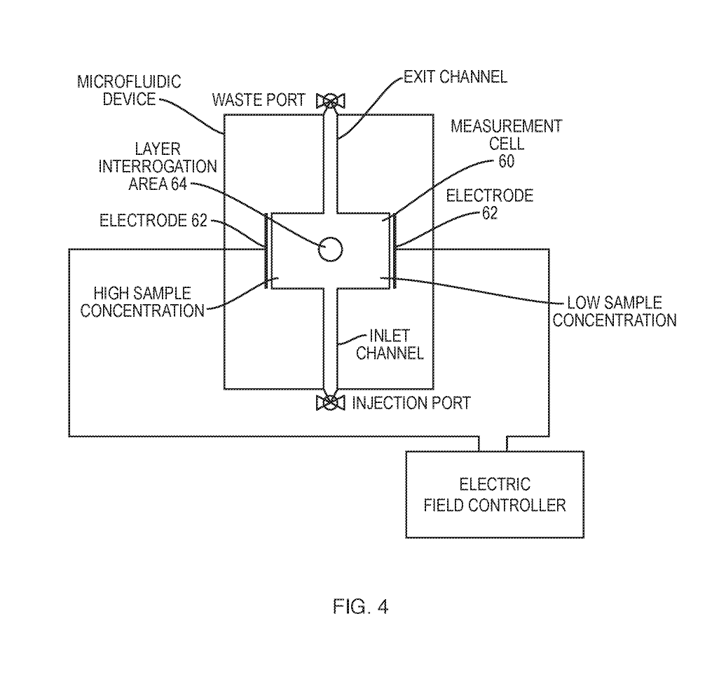

FIG. 4 illustrates the construction of a microfluidic measurement cell where a solution of charged molecules, such as a protein or nucleic acid in buffer or water, is introduced through an inlet channel into the measurement cell 60. Electrodes 62 on either side of the cell are used to create an electric field across the solution causing the charged molecules or particles to migrate to one side or the other of the cell depending on the field polarity and the charge on the molecule or particle. Particle size may also effect the location of the particles or molecules over time, as will time exposure to the electric field or time varying modulation of the electric field. By modulating the electric field strength and polarity the molecules or particles can be moved from one side of the cell to the other. The light (e.g. laser) probe beam can probe an area of the cell such that the sample concentration is modulated across the laser interrogation region (or area) 64 allowing for a differential measurement. The probe beam can be moved to different physical locations in the cell depending on the characteristics to be measured and the physical properties of the measurement technique, including sample properties, field strength, cell geometries, number of different analytes, etc. This method has the advantages of the fluid modulation methods described previously but can used in either a flowing or a non-flowing system as described for MMS. When the measurement is complete, the sample fluid may be flushed out of the measurement cell to waste or recycled for further use.

In other embodiments of the invention:
A static or dynamic concentration gradient may be formed, the gradient used to analyze the effects of concentration or particle size on the sample under measurement
The “sample” may contain more than one analyte, the electromagnetic field creating a spatial separation between the analytes over space, time or both allowing multiple analytes to be measured in a single fluid
Kinetics can be studied (e.g. protein aggregation or unfolding) as different species are formed and electrophoretically separated.
Stability studies can be formed by introducing thermal or chemical (pH, denaturants) and measuring the relative change in sample secondary structure
In one embodiment, the fluid may be flowing through the cell, creating a two-dimensional geometry such that the further into the cell from the inlet, the more the interaction of the electric field and sample separates the analytes in the cell. The light beam position may then be moved or swept to difference locations in the cell to measure variations in a characteristic in the cell. The electric field may further be time varying, such that at any location in the may represent a different timing varying physical property of the fluid as determine by motion of an analyte in the fluid. Thus a modulated signal can be generated at various locations in the cell by modulating of a fluidic characteristic at one location, or motion of an interrogation region across different cell locations. Motion modulation may be synchronous or asynchronous with motion of the fluid in the cell resulting from flow into the cell (i.e. pressure induced flow in an inlet channel
In one embodiment two fluids may be introduced into the cell such as is known as laminar flow parallel streaming, and an analyte in a first fluid may be moved into the second fluid by the electric field (and in another embodiment, an analyte in the second fluid may be moved in the first fluid). This may be advantageous in measurement of kinetic interactions of analytes and fluids. Different levels of fluidic mixing may be introduced by the motion of analytes or particles between the fluids. The fluids may have different velocities in the cell, and stop flow techniques may also be used.

In one embodiment, wavelength modulation spectroscopy may be used to characterize proteins by looking at the slope of the spectral absorption curve at one or more wavelengths. This technique may be used in a non-flowing cell during measurements (i.e. stop flow). Slope measurements at a given wavelength may have reduced dependence on the protein concentration with the potential to be extremely sensitive. Selecting a small number of wavelengths with high information content may uniquely characterize the protein (i.e. protein similarity, fingerprint) and be much more efficient in terms of measurement time, sensitivity). Slope measurements may be made by measuring two or more wavelengths in a step wise manner, or by continuously scanning the wavelength, both as well known in the art as used in gas phase modulation spectroscopy.

Avoidance of Wavelengths

The system may measure fluid samples which may have broad absorption band features by using a high-resolution laser to measure absorption at discrete measurement frequencies that minimizes the interference with gases which may also be present and which typically contain very narrow absorption bands.

IR measurements that cover the spectral regions where there are strong atmospheric interferences can be problematic. Atmospheric absorption bands, such as water and CO2, consist of relatively narrow (˜0.1 cm−1 FWHH) bands with relatively large spacing between bands (up to 5-6 cm−1) (the “interference”). In comparison, condensed phase spectra are very broad with absorption bands rarely below 8 cm−1FWHH (the “sample’). With conventional IR spectrometers, such as FTIR, condensed phase measurements are typically made at an instrumentation resolution of 2 to 8 cm−1. This approach is commonly taken due to the trading rules associated with conventional spectrophotometers where one must balance sensitivity (signal-to-noise) with resolution. As such, the narrow line widths of the atmospheric interferences are convolved with the low-resolution instrument line shape causing the interferences to overlap with each other and the broader condensed phase bands.

As such, it is common practice to digitally subtract the contribution of the interference from the measured sample. However, subtraction can be subjective and/or small frequency shifts in the data can cause errors in this correction which result in measurement errors of the sample. One common approach to minimize this problem is to purge the spectrometer with dry air or nitrogen to minimize atmospheric interferences. In spite of this common practice, it is very difficult to achieve an environment with no water vapor. In addition, if the purge needs to be broken to insert a new sample, the operator must wait some period of time for the interferences to be reduce to an acceptable level, delaying the measurement and reducing the instruments effective sample throughput.

Instead of a conventional spectrometer to make the IR measurement, a high resolution tunable source, such as a mid-IR laser, can be used for sample measurements. For a mid-IR laser, such as a QCL, the laser can be run in continuous wave (CW) mode which provides an extremely narrow bandwidth source (typically >0.001 cm−1). The laser can then be tuned in discrete steps (e.g. every 2 cm−1) to accurately sample the spectral profile much as one would by using a conventional IR spectrometer. However, one can take advantage of the narrow line width to choose sampling points such that the fall between the narrow lines of the atmospheric interferences. This approach minimizes the effect of the atmospheric interferences in the free space region of the spectrometer system, reducing the need for a high quality purge and improving the accuracy of the measurement by avoiding the interfering bands.

While water vapor was used as one embodiment, it should be clear to those versed in the art that other spectral interferers can be avoided in the same manner. The measurement system may have a calibration method that detects interferers in the analyte, reference fluid or spectrometer system, and selects operating wavelengths to avoid interference. Thus one method of operation of the analyzer may include (1) Using an optical source in the detection of an interferer signal in the measurement of an analyte characteristic, (2) changing of an optical characteristic of the optical source to reduce the magnitude of the interferer signal, thereby providing an improved measurement of the analyte characteristic.

The measurement system may periodically measure the spectral absorption band of a water or other interferer as part of a system calibration of wavelength, and the system may then determine the wavelength at the center of the absorption band, and use the measurement to verify or update the wavelength calibration of the measurement system.

Displacement Measurement

Changes to the volumetric displacement or apparent specific volume of a solvent by an analyte may be created by a change in the conformation of the analyte. This may be the case when, for example, a protein denatures and exposes hydrophobic sections of the molecule, which in turn changes the hydrodynamic radius. Determination of a change in volumetric displacement may be particularly useful when direct measurement of the analyte conformation is not possible because of incomplete or mis-targeted wavelength coverage when using optical detection. For example, in a single-wavelength system (non-tunable, fixed wavelength), protein conformation cannot be determined because there is no complete infrared spectrum of the Amide I band. Even still, differences in absorbance between native and denatured proteins in a buffer may be readily apparent because protein unfolding leads to changes in the displacement of the buffer, which may be highly absorbing at the available wavelength. This is an effective and sensitive method for tracking protein stability.

In another example, conformation changes in the tertiary and quaternary structure of proteins—but not involving the secondary structure—might not be detectable when probing the Amide I band which is sensitive only to the secondary structure. However, if these conformation changes lead to changes in the displacement of the buffer, which does have an absorbance signature in the Amide I band, then measurement of protein stability is possible.

Measurement of solvent displacement may be performed in a number of ways, including but not limited to direct measurement of volumetric change, measurement of pressure change, and spectroscopic measurement. In direct measurement of volumetric change, for example, the volume of a native protein in buffer solution is first measured, before it is heated to denature the protein and then cooled. (Evaporation must be prevented to avoid loss of water). The volume is then re-measured. Any differences would be attributed to an irreversible change in the conformation and displacement of the protein molecules. Similarly, changes in the pressure of a sealed container would indicate a change in volumetric displacement after denaturing. Examples of spectroscopic measurement are mentioned above.

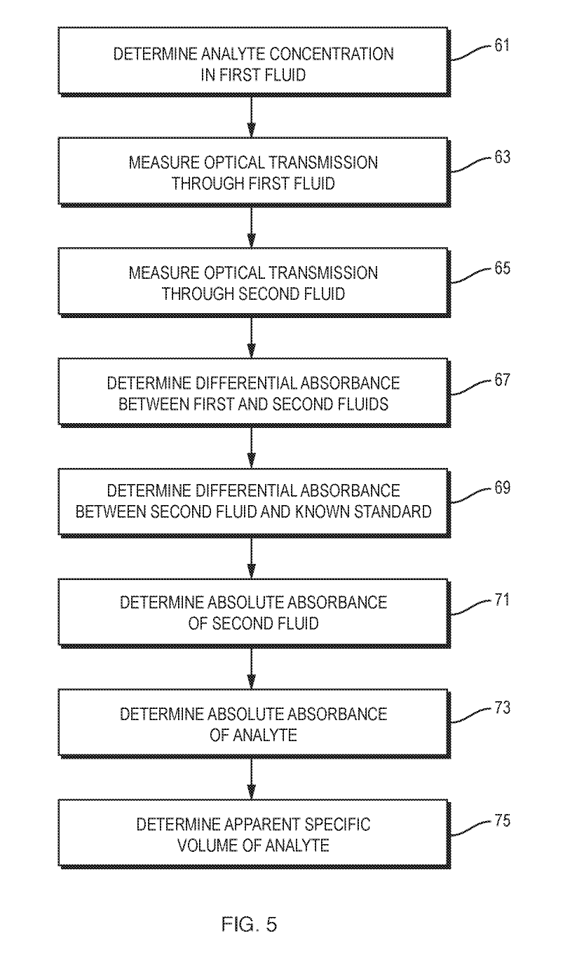

Thus, as shown in FIG. 5, in one embodiment a method for determining the apparent specific volume of an analyte in a first fluid with an analyzer, comprises:
determining the analyte concentration in the first fluid (61);
measuring the optical transmission through the first fluid (63);
measuring the optical transmission through a second fluid, the second fluid being nominally the same as the first fluid without the analyte (65);
determining differential absorbance between the first fluid and the second fluid (67);
determining differential absorbance between the second fluid and a known standard with known spectral absorbance profile (69);
determining absolute absorbance of the second fluid (71);
determining absolute absorbance of the analyte by subtracting a fitted fractional contribution of the second fluid from the first fluid (73); and
determining apparent specific volume of the analyte from the fitted fractional contribution value (75).

The method may additionally comprise determining a change in a physical property of the analyte (e.g. protein tertiary structure) in addition to or instead of fitting step 75.

Displacement Factor

When a substance (i.e. analyte) is dissolved in solvent (e.g. water or buffer) to create a sample, the analyte displaces some amount of the solvent (true for suspensions as well). To obtain the true absorbance spectra of an analyte in solvent using differential absorbance measurement techniques, the amount of solvent displaced by the analyte must be known. This is referred to as the displacement factor, which is specific to a particular pairing of analyte and solvent. Different solvents may yield different displacement factors for the same analyte.

Displacement of the solvent by the analyte may not be a 1 to 1 displacement ratio. For example, 1 gram (or equivalent mole) of analyte may displace 0.5 gram (or equivalent mole) of solvent, yielding a displacement factor of 0.5 in its native conformation. This value can be determined by matching to a known reference spectra for the analyte (e.g. protein) or by running a concentration series (all calculated 100% absorbance curves must overlap). The displacement factor, therefore, may be a relative measure of a hydrodynamic radius of the protein molecule (relative to the solute). If the protein is stressed or denatured such that it unfolds, exposing the hydrophobic regions in its structure, then the hydrodynamic radius may change, and this will be reflected in a change in the displacement factor. Because the solvent (e.g. buffer, water) may be a very strong absorber in the infrared, small changes in the displacement factor may yield large changes in sample absorbance, making displacement factor a sensitive metric to protein conformational change (including both secondary and tertiary structure). Thus, in one embodiment, change in analyte conformation may be determined by calculating the displacement factor from the measured differential absorbance data and comparing it to its known native conformation displacement value.

As disclosed, to obtain the absolute analyte or sample absorbance spectrum, both the displacement factor and the absorption spectrum of the solvent may be required. One method of obtaining this solvent spectrum in a differential measurement system is to use an optically transparent analyte at the measurement wavelength of interest (i.e. for an infrared absorption measurement) mixed into the solvent and performing a differential measurement against the pure solvent. This optically transparent analyte must have a known displacement in the solvent being used. Another method is to perform a differential spectral measurement against another fluid with a known spectrum (e.g. water) and then “subtract” the known spectrum to get the solvent spectrum. This approach offers some computational simplicity as there is no mixing and no displacement factor to account for.

For clarity, three terms are defined: “Sample” refers to analyte-in-solvent. For example, this may be protein in buffer solution. “Reference” refers to the reference fluid or solvent itself. For example, this may be the buffer solution. “DiffAU” refers to the differential absorbance measurement between the Sample and Reference. “Buffer Absorbance” refers to the solvent absorbance spectrum in the spectral region of interest.

Once the DiffAU and the Buffer Absorbance are known, the displacement factor can be determined by fitting of calculated spectra (see “Mathematics” section below) to known values. For example, the displacement factor may be chosen to produce zero analyte absorbance in spectral regions where the analyte is known to have no absorbance. Note that the wavelength used to measure the displacement value may be a different optical wavelength than that used to measure certain physical characteristics of interest in the buffer or analyte.

The displacement factor may also be determined empirically in a separate volumetric experiment where G grams of analyte are added to V milliliters of solvent. The resulting volume change, dV , is measured. The ratio dV/G is the displacement factor.

It should be noted that in a differential measurement system (e.g. MMS), there may be a fixed bias that exists between the acquisition of the Sample and Reference absorbance data that is not derived from the analyte or solvent specifically. Sources of this bias may include but are not limited to small pressure and pathlength differences occurring between the Sample and Reference acquisition phases of the differential measurement. To account for this bias, an offset correction may be applied to all measurements. This can be accomplished by comparing identical fluids (i.e. Sample=Reference) as the differential measurement. The resulting DiffAU is the offset correction.

In another embodiment, multiple absorbance measurements may be used to determine the changes in displacement as a function of sample changes through comparison of multiple spectral measurements. Sample changes may include changes in analyte concentration, changes in the analyte containing sample fluid (i.e. denaturation), or changes in sample environment (e.g. flow rate in the cell, sample temperature, laser power, sample pressure). The spectral comparison calculation may include fitting a displacement factor to each of the measured absorbances and then comparing each of the resulting curves.

In another embodiment, the change in the fitted displacement factor calculated from fitting two absorption spectra (which may have the same buffer and protein concentration in the case of a protein characterization measurement) which may indicate a change in the hydrodynamic radius or other radii of the protein molecule which could result from a change in the protein structure (i.e. conformation change). When the buffers are unchanged (or identical between multiple samples), then differences in displacement factor can be used as an indication of conformation change, including aggregation effects. To account for both structural changes and displacement changes that result in changes to the absorption spectrum, multiple wavelengths of measurement may be used. For example, at wavelength A where there is little or no protein absorbance, the observed absorbance differences are principally from conformational changes and at wavelength B where there is strong analyte (e.g. protein) absorbance, absorbance differences are principally from conformational changes (e.g. for proteins a change in beta structure).

Mathematically:

Translation of code being used in a measurement analysis routine for the case of a differential absorption measurement of water versus a buffer containing protein analyte.

bs=buffer-sample diffAU (what is measured as a differential in absorption units); sign is flipped to become sample-buffer

wb=water-buffer diffAU; sign flipped to become buffer-water

waterAU=absorption spectrum of water, known from Bertie, literature

conc=protein concentration in the buffer (unitless, fraction)

bAU is the buffer absorbance, determined from known water spectra and a water-buffer (wb) measurement

bAU=waterAU+wb=waterAU+(bufferAU−waterAU) Equation (1)

bsAU is the absorbance of the buffer-sample mix (buffer protein mix)

bsAU=bs+bAU=(buffersamplemix−buffer)+buffer Equation (2)

sample absorbance at the measurement cell pathlength is:

sAU_{df1}=buffersamplemix−buffer_absorbance(1-conc)
but this (1-conc) term assumes straight 1:1 displacement (lmg protein displaces luL of water)
does not have to be so!
The displacement could be 1:2 (displacement factor=0.5), for example.
so scale the displaced buffer by (1−displacefactor*conc)

So, accounting for the displacement factor, the proper sample absorbance at the measurement cell pathlength, is:

sAU_{df1}=(bsAU−bAU*(1−displacefactor*conc))

It is common and advantageous to normalize the absorbance profiles to 100% concentration (in measurement cell pathlength) to allow for direct comparison of protein spectra taken at different concentrations.

sAUnorm=(bsAU−bAU*(1−displacefactor*conc)/conc Equation (3)

“displacefactor” is treated as a fitting variable, typically found to be near 0.5, which when chosen properly yields good agreement between the calculated sample absorbance (sAU) of the protein in question and the model curves for the same protein found in the published literature (e.g. Univ. of Northern Colorado Protein Database). This is relatively straightforward to do using well-known computational fitting methods. However, this may become more difficult to do when there is no known reference. This may be the case for new proprietary proteins or for denatured proteins. In both these cases, it may be necessary to match specific sections of the spectra which are common to most or all proteins, denatured or otherwise (e.g. 1800-2000 cm⁻¹).

When comparing protein measurements between different samples, a change in absorbance profile due to protein conformation change, for example, is typically accompanied by a change in displacement factor. In fact, there may be cases where the differences in absorbance spectra are very small but the displacement factors may change significantly. Therefore, displacement factor can be used as a proxy for protein conformation change which is useful when conventional methods for detecting conformation change are not adequately sensitive as previously disclosed.

Below, the terms “sample” and “protein” are used interchangeably. The terms buffer and solvent may also be used interchangeably. A method for determining the displacement factor may comprise the steps of:
(1) obtaining differential absorbance measurements of a first sample (“bsAU”) using techniques such as MMS.
(2) Obtaining protein concentration (“conc”) from known sample preparation (e.g. 10 mg/mL in buffer)
(3) Calculating the buffer absorbance (“bAU”) (e.g. by using the Equation 1 above).
(4) Determine the absolute absorbance of the protein (“sAU”) (e.g. by using the Equation 3 above. This requires a value for the displacement factor (“displacefactor'), obtained using methods described earlier in the section following Equation 3.) Specifically:
   a. Adjust/fit the value of the displacement factor so that the absolute absorbance spectrum of the protein (”sAU“) matches the model (”known“) spectrum.
   b. If a model spectrum for the same protein is not available, it may be necessary to match “sAU” to specific sections of a proxy model spectrum (e.g. a generic monoclonal antibody) which are common to most or all proteins. These typically include the region between 1800-2000 cm−1, and the spectral “tails” exhibited by most proteins near 1600 cm−1 and 1700 cm−1.

HPLC Detector

In one embodiment, the system may be used as an HPLC (LC or liquid chromatography) detector. In this embodiment, a liquid chromatography detector includes a column output generating a first fluid containing an analyte in a first time slot; an optical source and an optical transducer defining a beam path of an optical beam; and a fluid flow cell with a fluid channel, wherein the beam path defines an interrogation region in the fluid channel in which the optical beam interacts with the first fluid and a second fluid resulting in transducer output signals, the second fluid substantially representative of the first fluid without the analyte, the second fluid generated in a second time slot. A controller is configured and operative as described below to measure a physical property of the analyte.

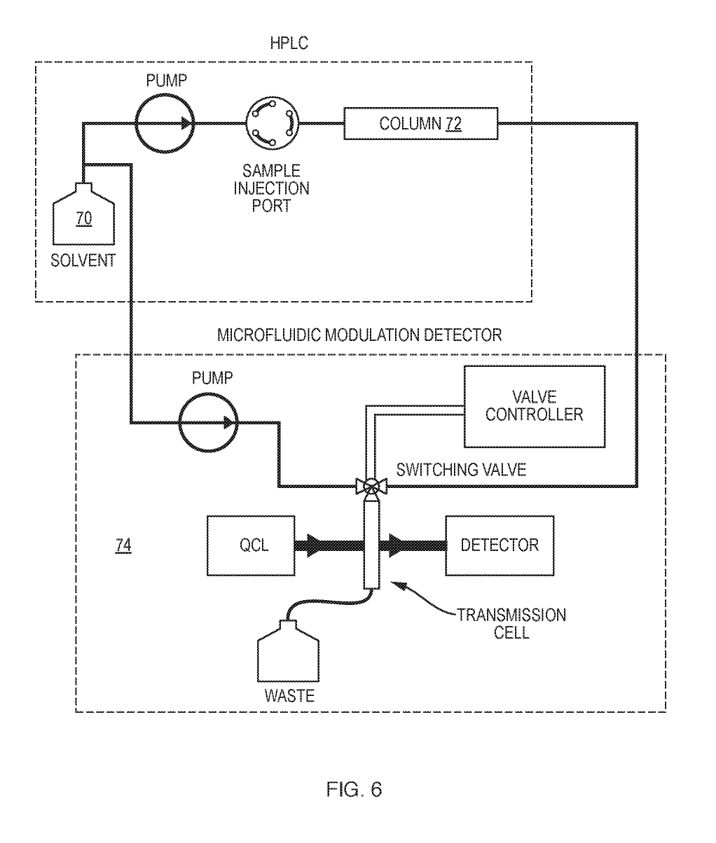

FIG. 6 shows one embodiment using an MMS system as an LC detector. The reference fluid is the LC solvent 70. This would typically be for isocratic LC (single solvent). As the sample fluid exits the column 72, the solvent and the sample are alternatively presented to the interrogation region of the MMS system 74.

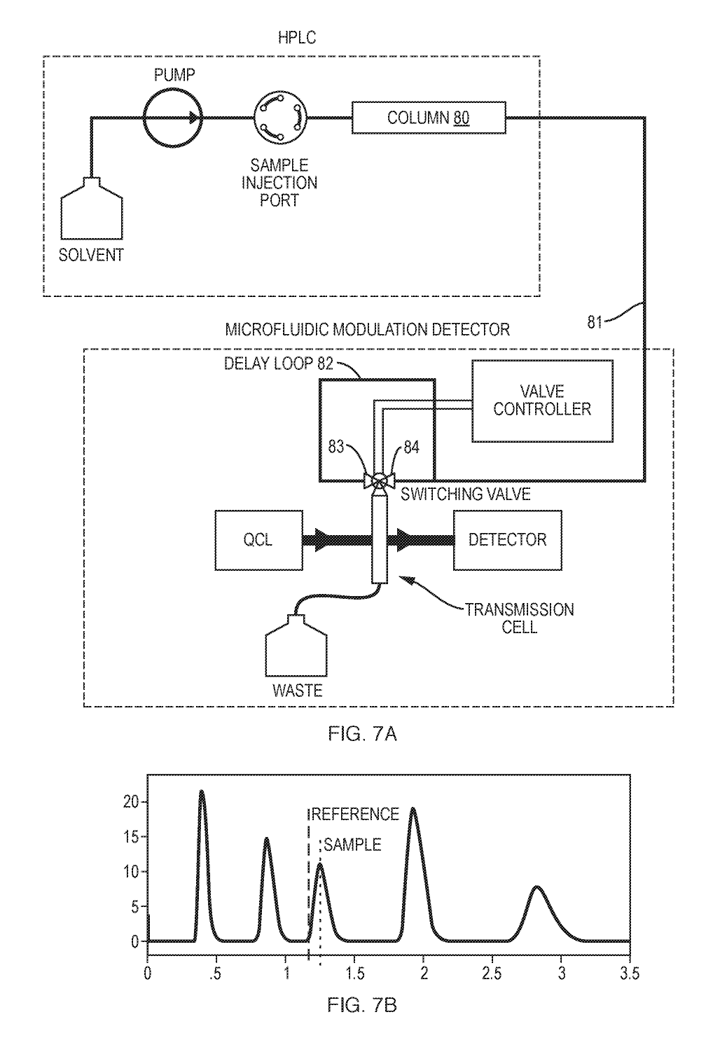

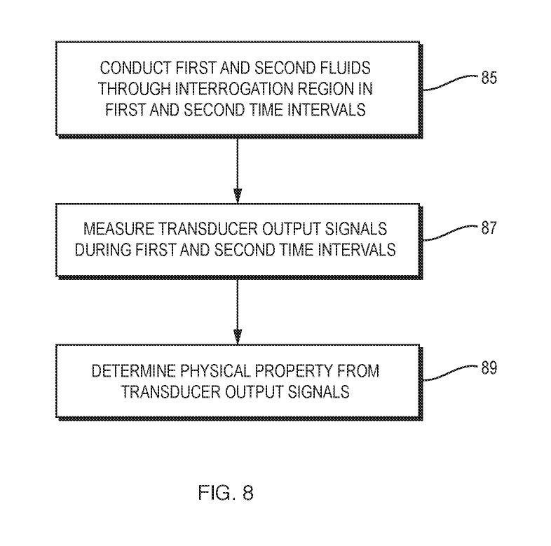

FIG. 7A shows an arrangement with an LC that is using gradient elution, in which the “reference” is continually changing and thus does not provide a static reference. In one embodiment, the output of the column 80 is “split” to capture the eluent 81 and place it in a delay loop 82 and then into the reference channel 83 of the MMS system for comparison with a subsequent column output presented into the sample channel 84. If the delay loop is approximately ½ the analyte peak width (or in a region between peaks) at the LC output as shown in FIG. 7B, a good reference background compensation and a derivative differential spectrum may be generated. Another embodiment may use microfluidics to generate a variable delay to match the peaks (as they elute they widen as a function of time). In one embodiment the fluidic cell may have multiple channels, each channel having a different length or different hydraulic impedance (i.e., through differences in channel dimensions) and thus a different delay time. The preferred channel may be selected by monitoring the signal on the optical detector to determine the width of the signal peak region. The preferred channel may be selected by the LC system. A valve external to the cell may be selected to select the preferred channel, or the valve may be incorporated into the microfluidic chip to present the fluid into the interrogation region. In another embodiment, the pressure used to push the fluid through the lines may be varied, a lower pressure creating a longer delay and a higher pressure decreasing the delay time.

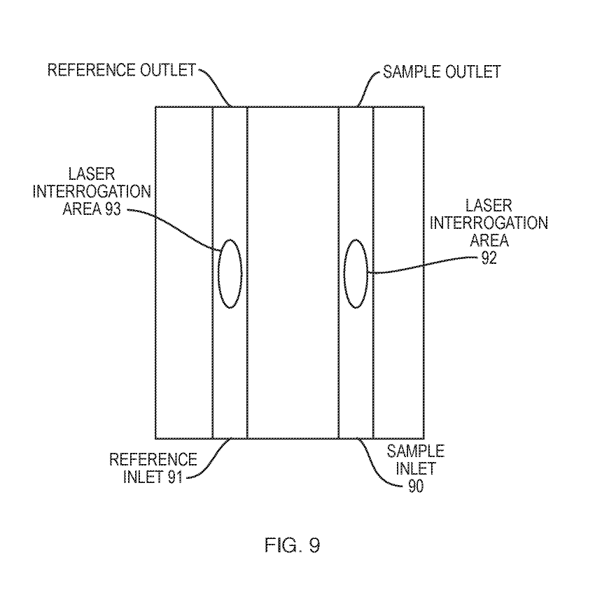

FIG. 8 shows operation of the analyzer. A controller is configured and operative to conduct the first fluid and second fluid through the interrogation region in first and second time intervals respectively (85); measure the transducer output signals from the optical transducer during the first and second time intervals when the first fluid and second fluid reside in the fluid channel (87), and determine from the transducer output signals a physical property of the analyte (89).

Dual Beam Microfluidic Modulation Spectroscopy

In some embodiments, it may be desirable to minimize the volume of sample consumed and to perform the measurement on a static sample. However, such an approach does not allow for the advantages of microfluidic referencing that is possible in a flowing system. An alternative approach is to split the measurement beam and pass it through separate sample and reference cells. This is an approach known by those skilled in the art and is sometimes referred to as dual beam or double beam spectroscopy. The challenge in this method is in matching the two beams to provide a stable reference in the second channel (i.e. identical to the first channel except for the difference in fluids) in the presence of system instabilities and varying optical beam power. Any difference in the path, optical components, detector components may reduce sensitivity and accuracy.

To minimize the sample volume consumed during measurement, it may be advantageous to reduce or stop the flow rate of the fluid modulation without sacrificing the ability to accurately baseline (subtract) the reference fluid. In one embodiment, the system measures the “sample” in one fluidic channel and the “reference” in a second fluidic channel, the channels being spatially separated at the point of optical measurement.

In another embodiment, two MMS sampling systems can be operated in two interrogation regions in a cell, the two systems operated simultaneously and optionally synchronously with each other, with buffer and sample being input into the sample channel of each MMS sampling system, and third fluid being used in the reference channel to obtain the differential measurement.

More specifically, in one embodiment a method of operating a fluid analyzer includes conducting a first fluid into a first region and a second fluid containing an analyte into a second region of a fluid flow cell of the fluid analyzer; illuminating a location within the first region and a transducer with an optical source to define a first interrogation region wherein the first fluid interacts with light from the optical source, the transducer producing a transducer first output signal; illuminating a location within the second region and the transducer with an optical source to define a second interrogation region wherein the second fluid interacts with light from the optical source, a transducer producing a transducer second output signal; conducting the second fluid into the first region and illuminating a location within the first region to produce a transducer third output signal; conducting the first fluid into the second region and illuminating a location within the second region to produce a transducer fourth output signal and determining from the first, second, third and fourth output signals a physical characteristic of the analyte. Consider: two paths (beam locations) in (a) the same single channel, or (b) two separate channels. It is understood that “two” can mean “two or more”.

If the optical beam is split into two paths, each passing through one of the two fluidic channels each with its own interrogation region, then measurement of each channel can be accomplished simultaneously using two detectors, for example, or can be time multiplexed onto a single detector. The latter embodiment avoids drift and offset differences between discrete detectors. The single detector measurement may be accomplished by using a chopper or moving a reticle to alternate between transmission and measurement of one beam path while blocking the other, or by modulating the beam at different frequencies in the different paths and separating the signals in processing of the detector output signal. Alternating between sample and reference can be accomplished rapidly by using an optical chopper. The same chopper may also be used to block both channels at once in order to remove background optical or electronic signals arising from sources other than the optical beam (e.g. detector dark current, optical emittance within the detector field of view).

In one embodiment, one of the two fluidic channels may contain a reference fluid while the second fluidic channel concurrently contains the sample with analyte of interest. The fluids may be static during measurement. This yields lower sample volume consumption during the measurement.

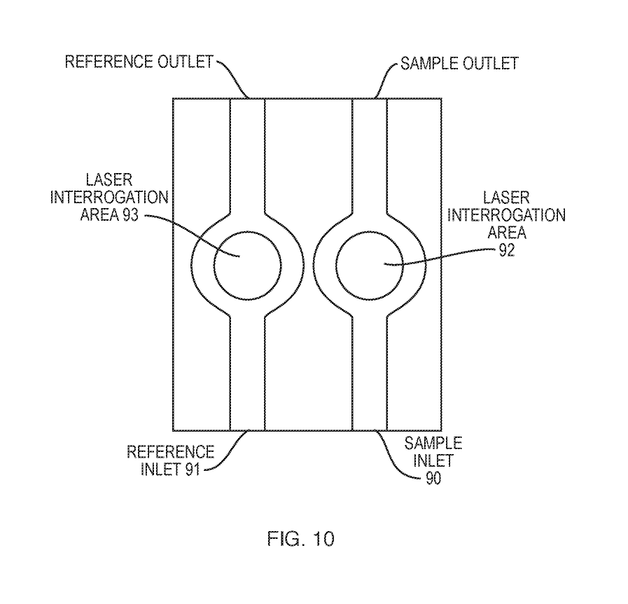

FIGS. 9-10 show that in one embodiment two channels of the dual beam system may be constructed from a single sample cell that contains the sample 90 and reference 91 channels. The channels may have different geometric shapes that allow the light source to be expanded or defocused to reduce heating effects on the fluids. The two fluidic channels may be contained within a single sample cell and located close together as shown in FIGS. 9-10, and the optical source may consist of focused laser light. In one embodiment, a collimated laser beam may be used to make a dual beam measurement that matches the two channels more precisely by minimizing the spacing separating the two beams to insure they are a closely matched as possible and co-linear. This also allows the use of a single optical detection system for both channels to eliminate the errors of separate detector channels. The physical spacing between interrogation regions 92 and 93 in the two channels may be less than 100 um. The physical spacing between regions may be less than 10 radii of the collimated optical beam presented to each of the dual beam interrogation regions. The interrogation regions and fluidic channels may be designed to have the same physical geometries, or they may have deliberate differences to induce a particular difference in the measurement (e.g. rate of flow), or to correct for differences between the reference and sample fluids (e.g. absorption). The channel region with the interrogation region may have a larger channel dimension (e.g. width) than the channel region before or after the interrogation region. Multiple reference and sample channels may be used, each with different channel dimensions or fluidic impedance to achieve certain flow or measurement characteristics of fluids with varying viscosities, absorbances, etc.,

In one embodiment, it may be important to match the two channels as closely as possible. In a conventional spectrometer, it is difficult to place the two channels close together due to the constraints of the source, optics, and focusing mirrors necessary to create a small sampling spot.

With a well-collimated laser, it is possible to space the beams a few millimeters apart, making practical the construction of a single two channel cell. Using the same cell for both channels minimizes system drift due to using separate cells that are commonly employed in dual beam systems. The window thickness, optical and thermal characteristics, as well as the channel depth can be much more easily matched if it is contained within a single cell then by using two separate cells. Two separate cells with different optical characteristics can change over temperature and time differently from each other which is a source of noise in a dual beam measurement. Finally, for measurements requiring precise temperature control, it is a matter of maintaining the same (matched) temperatures in a single (i.e. monolithic), dual-channel cell with closely spaced fluidic interrogation regions.

Flowing fluids may also be used in one or both channels. The rate of fluid flow may be determined by the amount of absorptive heating of the cell or fluids by the optical beam, wherein the flow rate reduces a differential signal between the beam paths due to the absorptive heating. The rate of fluid flow may be determined by the rate of interdiffusion at the boundary of different fluids within a single microfluidic channel. In one embodiment, the system may operate in stop flow with one sample fluid in the interrogation region and a second sample fluid in the channel outside the interrogation region, and the system may measure a change in the absorbance in the interrogation region due to the diffusion of the second sample fluid into the first fluid within the interrogation region.

Parallel or serial streaming fluid modulation in a single channel as used in MMS may be used to achieve channel-vs-channel offset measurements for signal correction or calibration in one or both of the dual beam channels. While optically coherent measurement systems employing dual-beam paths can achieve great sensitivity, they may be sensitive to differences in the optical paths and optical signals of the two separate beam paths which do not represent the sample signal of interest. A channel fluid offset measurement with a common fluid (or a gas) in both channels (e.g. the reference fluid is commonly used) may be used to measure and compensate for such channel to channel differences. This offset may be calculated and effectively subtracted from the dual beam differential (i.e. sample-reference) measurements to correct for differences in the optical beam paths and measurement signals not attributed to differences in the absorbances of the fluids under test. This channel fluid modulation offset measurement may be performed at a slower rate than when using single-beam microfluidic modulation spectroscopy (MMS). The rate may be slower than once a minute. The rate may be determined from the magnitude and rate of change of instabilities in the two beam paths that result in a detection level matching the desired sensitivity of the differential measurement between the signal and reference channels.

In one embodiment, parallel or streaming MMS may be performed in both channels in a synchronous manner. For example, each interrogation region may simultaneously contain sample fluid and then reference fluid. In another embodiment, the fluid changes in each interrogation region may be synchronous but out of phase (e.g. by a ¼ or ½ cycle). For example, the first interrogation region may contain a sample fluid while the second interrogation region contains both a sample and a reference fluid.

Thus in an embodiment of a dual beam fluidic modulation system, the dual beam measurement may be used to correct for short term common mode system fluctuations that are common between the two beam paths and interrogation regions, and fluidic modulation may be used to determine an offset between the two channels for differential mode signals that are not common between the two paths, and then the system may use fluidic modulation to correct for changes in that offset over time due to system instabilities that result in an unwanted differential signal between the two beam paths. The frequency of (i.e. the rate at which the two fluids are passed through the cell) may be much lower than in a single beam system as previously disclosed (i.e. 0.01 Hz in dual beam versus 5 Hz in dual beam)

Thus in one embodiment or method, the following may be performed:
1. Sample fluid and reference fluids are positioned in the interrogation regions of the beam 1 optical path and beam 2 optical path in fluidic channels 1 and 2, respectively, within the dual beam system.
2. With beam 2 blocked such that the optical signal from beam 2 does not impinge on the detector common between beam paths, a measurement of the beam 1 signal is performed with the detector. The signal may be averaged over multiple detector measurements.
3. With beam 1 and 2 blocked, a “dark” signal may be measured for use in removing certain detector and other system offsets.

4. With beam 1 blocked such that the optical signal from beam 1 does not impinge on the detector, a measurement of the beam 2 signal is performed with the detector. The signal may be averaged over multiple detector measurements.
5. Steps 2 and 4 (and optionally 3) above may be performed more than one time and at more than one spectral wavelength of the optical beam
6. The fluid in channel 1 may be replaced with another fluid (e.g. the reference fluid) 7. The fluid in channel 2 may optionally be replaced with another fluid (e.g. the sample fluid)
8. Repeat Steps 2 and 4, and optionally 3 and 5.
9. The system uses the detector measurements of steps 2, 3, 4, 5, 6, 7 and 8 above to determine the differential transmission of sample and reference fluids

It should be obvious to those versed in the art that various combinations and sequences of steps above may be performed and it may be advantageous to leave certain steps out. The fluid modulation may occur at a rate slower than the rate of sampling and averaging of the detector signal in steps 2 and 3. Measurements may be taken while the fluids are flowing through the interrogation regions or under stop flow conditions.

A dual-beam approach may decouple the fluid modulation behavior from the measurement of optical absorbance of the fluid. Because the sample and reference fluids are in separate channels, they can be measured with zero or near-zero flow without consideration to diffusion or mixing. In this manner, the measured signal may be unaffected by the surface tension, density and viscosity of the fluid, which could otherwise affect operational parameters used in a more dynamic measurement technique including the flow rate, back pressure, optical offsets, optimal modulation rate and measurement duty cycle.

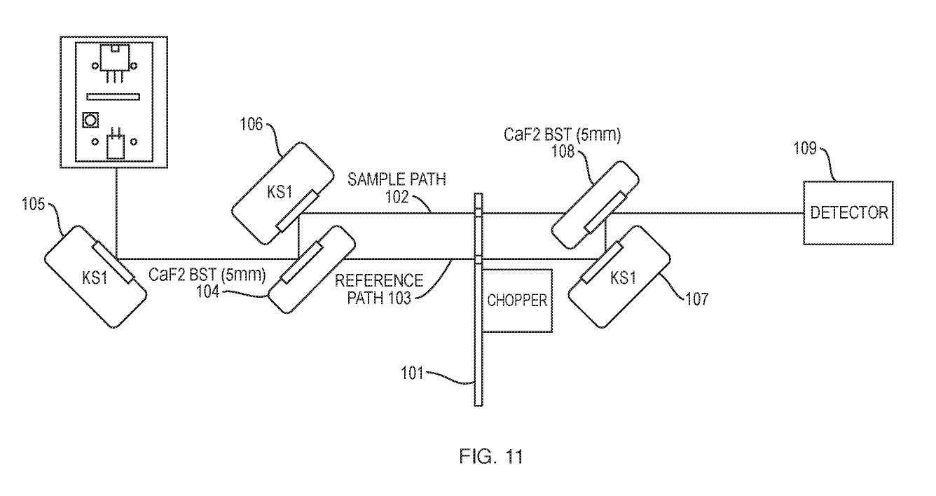

FIG. 11 shows a dual beam configuration without the fluidic cell which may be placed on either side of the chopper wheel 101 that alternatively passes to detector 109 or blocks each of the sample 102 and reference 103 path beams (i.e. 180 degrees out of phase), and may include blocking or passing of both beams simultaneously. Beams 102 and 103 may be generated with a beam splitter 104 together with an arrangement of reflectors 105, 106, 107 and second beam splitter 108.

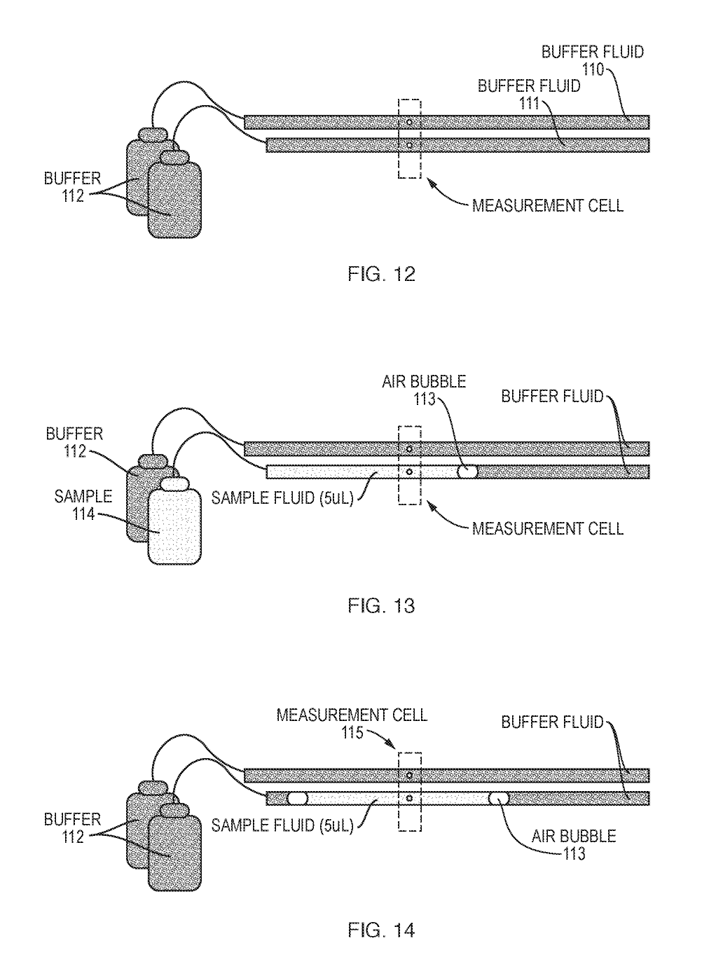

FIGS. 12-14 describe an embodiment in which one sample scan with only one channel offset measurement is employed. In this embodiment, it may be advantageous to manipulate the fluids without valves and dedicated lines which usually introduce a fluidic volume penalty. In this embodiment the sample and reference channels may first be flushed with a fluid (e.g. “buffer”) with an absorption that is measurably different than the fluid sample to be measured (e.g., “sample”). A “sipper needle” (e.g. syringe pump connected needle or pressure driven tube) may be placed in the sample vial, wherein the “sample” is pulled or pushed into the fluid line and then pushed through the line and into the cell for measurement. With monitoring of the channel-channel ratio, it may be possible to measure when the sample arrives and enters the optical beam path. The sample in the line may be pushed along by air or another fluid (for convenience, this fluid is referred to as the “buffer”). If by buffer, then there must be consideration for diffusion at the fluidic boundary. If by air, the measurement should be complete before the sample exits the beam path. Edge or bubble detectors (e.g. visible camera, LED) may be placed on either side of the beam path measurement area to determine when the sample volume has safely entered the measurement area and when it is about to exit.

FIGS. 12-14 show the progression. FIG. 12 is an initial condition in which buffer 112 is in both lines (e.g. tubes or channels) 110 and 111 of a dual beam system. FIG. 13 shows a later stage in which the sample 114 has been introduced into one of the lines, preceded by a bubble 113 serving as both a marker and fluidic separator buffer 112 at the beginning of the sample 114. FIG. 14 shows an even later stage in which a trailing bubble and separator 115 has been introduced to mark the end of the sample. The embodiment as described is applicable to both MMS single beam and dual beam analyzer systems.

The cell architecture is simplified because Y-branches and valves are not needed, and this leads to reduced sample volumes.

A method of measuring a property of a fluid includes:
defining a beam path with an optical source and an optical transducer; defining an interrogation region in the fluid channel of a fluid flow cell, wherein the beam path interacts with fluids to generate optical signals measured by the optical transducer;
creating sequential adjacent spatial regions of a first fluid, a separation fluid and a second fluid in a flow path connected to the fluid channel;
conducting the first fluid, the separation fluid and the second fluid through the interrogation region such that the interrogation region contains predominately the first fluid in a first time interval and primarily the second fluid in a second time interval;
measuring a first and second interrogation signal with the optical transducer in the first and second time interval respectively; and
processing the first and second interrogation signal to determine a first property of the first fluid or a second property of the second fluid

In another embodiment, the fluidic cell may be removable and disposable. The cell may be “preloaded” with reference and measurement (sample) fluid external to the system and then mechanically inserted into the path of the optical beam. The cell channels may be connect to external lines for the introduction of these fluids into the cell if not preloaded. Once connected, reference fluid may be introduced into both channels, providing for channel-channel offset measurements in accordance with previous embodiments.

Below are three embodiments that may be employed in a dual beam measurement system:
1. Two static samples, one beam steered between them. A mechanically moving mirror, redirects an optical beam between the two channels; effectively an infinite number of paths may be accommodated. With static samples, very low sample volume consumption;
2. Two static samples, two optical beams, alternatively directed to one or two detectors. There is no moving beam (blocking chopper may be used for very fast modulation) and with a maximum 50% duty cycle, very little dead time, and;
3. Two dynamic (flowing) fluid samples, two optical beams, alternatively directed to one or two detectors. With flow, one solves the problem of offset drift between channels (sample locations) over time which would otherwise limit signal-to-noise ratio. This allows water-water offset measurement at low frequency (once per temperature setting or once per minute, for example).

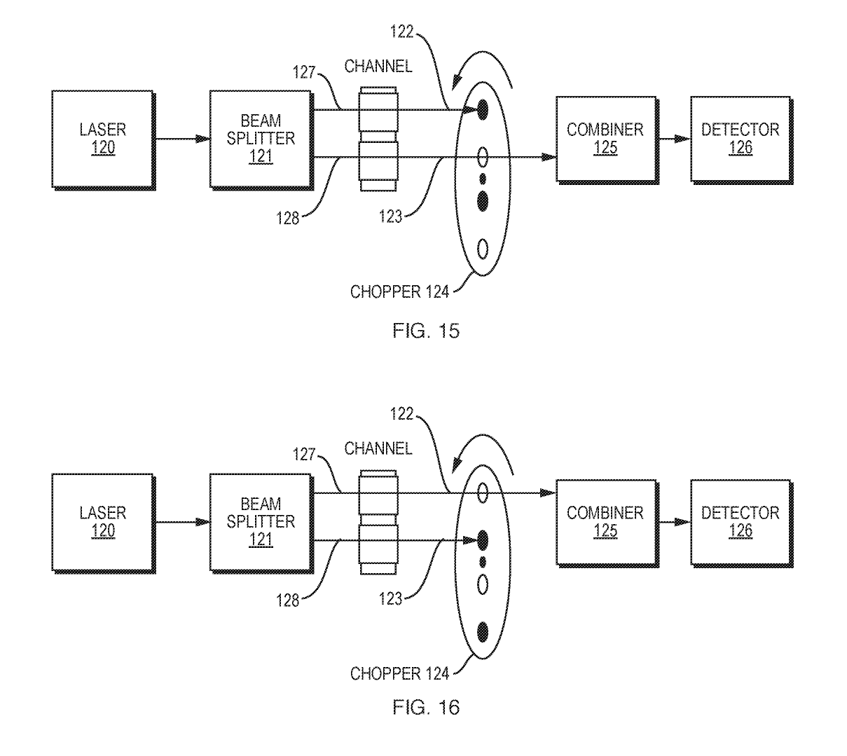

FIGS. 15 and 16 show a configuration in which a single static fluid sample (“slug”) can be used for the “sample” measurement and a separate fluid slug, also static, can be used for the reference measurement. The illustration above also shows two optical paths 127 and 128 that are static (not steered). Modulation is achieved by blocking one beam and transmitting the other with chopper 124. The optical path includes laser 120, beam splitter 121, beam combiner 125 and detector 126.

In this description it is assumed that channel 122 is for the sample and channel 123 is the buffer/reference. Fast modulation (e.g. >100 Hz) between the two static slugs is achieved by optical chopper 124 which is capable of achieving very fast modulation rates. Additionally, this reduces the system noise and drift contributions and has the potential of improving the system sensitivity.

Because the slugs are static during M multiple measurements, there is a factor savings of Mon sample volume relative to a flowing system that consumes one slug of sample volume per data point. For example, measuring 10 coadds at each of 34 wavelength positions using a single sample and single reference slug achieves M=340 times sample volume savings.

A two-beam system may be vulnerable to offset differences between the two optical paths, which may drift over time as described previously. In one embodiment it may be desirable to periodically take offset measurements to eliminate the differences from the determination of the sample to buffer differential measurement. This may be performed in a manner that decouples the high modulation rate necessary for ratioing the two channels, as the high modulation rate is accomplished separately using the chopper 125. Slow period offset drift correction between channels is measured by having each channel behave as an independent cell, with the ability to dynamically select between at least two fluids. That is, channel 122 has the ability to flow fluid 1 or fluid 2 (more than two fluids are possible as well as more than two interrogation regions). Similarly, channel 123 can be designed to do the same. In this manner one can then flow buffer in channel 122 and buffer in channel 123 and measure a complete offset profile over the Amide 1 band, for example. Once captured, channel 122 can push the buffer slug out and replace it with a slug of protein-in-buffer. Then a partial or complete sample measurement can be taken. A sequence may comprise:

| step | channel1 | channel2 | description |
|---|---|---|---|
| 1 | slug1 = buffer | slug2 = buffer | offset scan, sweep through |
| | | | amide1 |
| 2 | slug2 = protein | slug2 = buffer | sample scan, multiple mea- |
| | | | surements; 10 coadds takes 0.1 |
| | | | second at 100 Hz modulation; |
| | | | 26 wavelengths at 5 sec per |
| | | | wavelength yields 130 seconds |
| 3 | slug3 = buffer | slug3 = buffer | offset measurement; 130 seconds |
| 4 | slug4 = protein | slug4 = buffer | repeat step2 |

In the sequence above, fill and flush are not considered. Each scan takes 130 seconds assuming a 4.9 sec laser tuning/settling step followed by 0.1 sec acquisition (10 coadds). An offset scan is followed by a sample scan. A complete Amide 1 sample wavelength scan, as written in the sequence above, uses a single slug of protein-in-buffer sample, which may be as little as 1 uL. A complete wavelength scan may be completed after step 2. Steps 3 and 4 may then be performed, for example, at a different temperature. An offset measurement may be taken for each optical wavelength measurement or after more than one optical wavelength measurement, or multiple times within each wavelength measurement (i.e. per MMS)

In summary, the described embodiment utilizes two optical beams. Doing so has several benefits:
preserves sample volume because constant slug modulation is not necessary
maximizes acquisition duty cycle because slugs are rarely moving
lowers laser noise because modulation rate is controlled by a chopper
addresses the two-path offset problem, both spatially and temporally, by having the ability to periodically perform a “water-water” test with no user intervention.
It builds on unidirectional fluid flow, albeit at very slow modulation (static or nearly static)

Various techniques may be employed to introduce the fluid to each measurement channel as follows:
Volume Method #1: no separation between protein sample and reference buffer. An embodiment may use simple smooth single channel, no valve (could be downstream) but diffusion and Taylor-Aris dispersion will contaminate one fluid with the other
Volume Method #2: use a “bubble” to separate sample & buffer, thereby eliminating fluid diffusion risk. requires droplet “sweep-up” and no bubbles in beam chamber. Depends on the surface tension of the liquid to keep itself together and off the walls when the bubble separator slug follows behind (i.e. no sheath). The shutter may be closed to protect the detector from high optical signal when fluids are absent in the interrogation region. An air bubble or hydrophobic or non-immiscible fluid may be used as a separator.
Volume Method #3: use air to flush the lines and cell between each fluid.
Volume Method #4: higher viscosity liquid for sweep-up between measurement fluids (e.g. methanol and ethanol are miscible in water at any concentration)

### Other Embodiments

In one embodiment, de-focusing of the optical beam on the sample cell may be used to minimize the power density and reduce heating of the fluid. Heating of fluid may result in unwanted signals as the spectrum of the fluid changes with temperature. By distributing the laser power over a larger area, by defocusing, this unwanted effect is minimized.

It is well known in the art that many materials show a strong spectral dependence on temperature. For example, in the mid-IR the water absorption band at ˜1650 cm−1 has a strong temperature dependence. When illuminating a sample with light, significant heating may occur which changes the absorbance spectrum of water. If this heating is different between the two channels of a dual beam system, it will impart an error in the measurement. Likewise, in a flowing modulated system such as MMS, different flow rates between the two channels may induce a temperature difference between the reference and sample fluid streams which would lead to measurement error. To minimize this error, it may be advantageous to spread the optical power over a larger area of the sample. For a circular measurement area, which may be used in a dual beam configuration, the simple defocusing of the beam on the cell can accomplish this. In a narrow channel, such as may be used in an MMS configuration, a cylindrical lens may be used which spreads the beam out into an elliptical pattern along the length of the channel.

Linearity of a spectral measurement is extremely important as it allows for accurate spectral measurements over a large concentration range without sample dilution or changing to different pathlength cells. Most spectrometers have at most 1 to 2 decades of dynamic range. In one embodiment, the power available in the laser source, low stray light, and the resolution of a laser may dramatically increase the dynamic range capability of the system.

The sources of spectrometer non-linearity are well understood. Factors effecting linearity include the instrument resolution bandwidth, the instrument stray light, detector and electronic non-linearity, as well as sample related effects. Most conventional spectrometers maintain a constant source illumination while scanning a spectrum. As the absorbance changes as a function wavelength, there can be a significant change in signal on the detector. If the detector shows any non-linearity over that range, the spectral measurement will be in error. For example, in the mid-IR spectrum, photoelectric and photoconductive detectors are well known to have a limited linear dynamic range and much care much be taken to minimize these effects. In a system with sufficient excess optical power, one can scan through the sample and adjust the source intensity such that the variation of power on the detector over the scan is minimized. The power range may also be chosen to provide the best signal to noise and the best linear range for the given detector/preamplifier configuration. In a system deploying a tunable laser, one can readily step scan through the wavelengths and adjust the power of the laser at each wavelength to maintain a near constant power on the detector. A series of neutral density filters, a continuously variable filter such as a polarizing filter, or controlling the laser drive current directly may be deployed. The differential nature of the MMS or dual beam measurement negates the necessity of precise source power control.

Power control of the light source to increase linearity may be difficult to accomplish with a rapid of continuous scanning instrument or in a multiplexed system such as interferometer or detector array based system. By using step scanning as in MMS, power control can be easily accomplished.

In one embodiment, the microfluidic cell may be designed to absorb or reflect away some of the optical beam energy. This may be advantageous when high optical power at the source is required to reduce optical noise but low optical power is desired in the interrogation region. The cell may be designed to have higher absorbance on the side of the cell facing the incoming optical beam and lower absorbance on the “exit” side of the cell facing an optical detector. The cell may be comprised of a front window and a rear window, the front window having higher optical absorption or reflection than the rear window. The front window may be formed from a plastic, polymer or other material that can be cast form molds in manufacturing. For example, the front window may absorb or reflect more than 30%, 60%, 90% or 99% of the incident optical beam, and may also have a wedge shape, with fluidic channels on the surface not facing the optical beam.

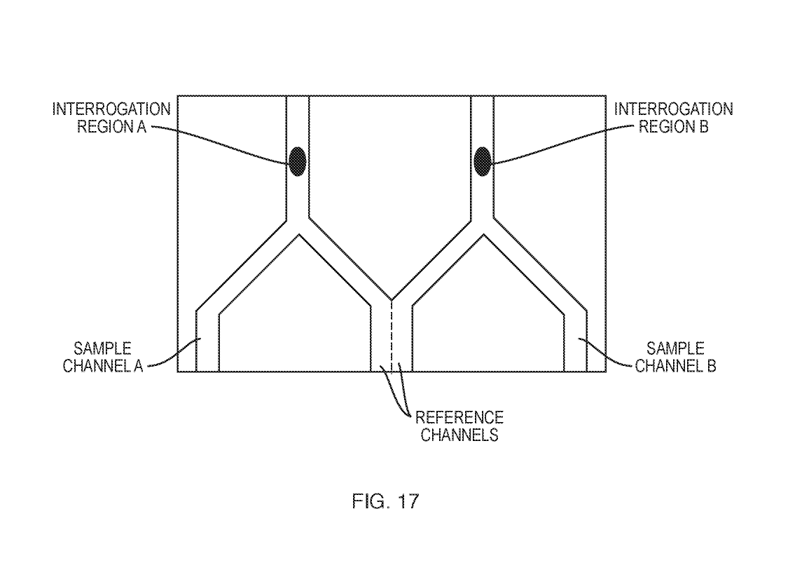

Other embodiments of the system may include the following:
1. The laser or other light source may be operated at a wavelength and power level that induces a temperature change in the sample (or reference fluid), the temperature change being used to change an optical characteristic of the analyte or the sample or the reference fluid (i.e. optical heating). The power level of the light source may be changed or modulated over time. Similarly, the light source may be used to induce a chemical change that is measurable by optical or other techniques.
2. A system with fluidic cell that flows in a fluid, “dries” or otherwise removes all or most of the fluid in the cell (e.g. by evaporation or pressurized air) and then measures a crystallized analyte, or a thin layer of analyte-bearing liquid on the cell walls in the interrogation region. The cell then is wetted to flow out the crystalized analyte. The cell may be dried by heating of the cell or by introduction of nitrogen gas or other gas.
3. A system with recirculating diluting fluids to perform automated dilutions to save sample test volume. For example, as the buffer and sample fluids exit the cell in the “Y” channel as describe previously, they are combined and recirculated back into the sample channel for measurement. The mixing ratio may be controlled by the flow rates of the two channels or by timing of the two channels (e.g. one channel may flow more or less time than the other channel).
4. As shown in FIG. 17, one embodiment of a microfluidic cell include fluidic channels A and B, interrogation regions A and B, and reference fluid channels that may or may not have a common input to the fluidic cell. The cell may be used for sample measurement in accordance with the MMS techniques as previously disclosed. In this embodiment, the two interrogation regions are used to reduce measurement time by having the interrogation regions measure samples 45 degrees out of phase with each other such that sample B (or reference) is being introduced into interrogation region B while sample A is being measured in interrogation region A. In one embodiment, the phase difference is 180 degrees (i.e. sample in Interrogation Region A and reference in Interrogation Region B. The advantage of this approach is that the time to measure samples is reduced. In a single interrogation region cell, measurement of the sample cannot start until the previous sample has been replaced in the cell by the new sample at a level determine by the desired performance of the system. In a multiple interrogation region cell as disclosed, measurements in interrogation region A may be performed (with a common detector) while the previous sample in interrogation region B is being cleared out in preparation for the next interrogation region B measurement. More than two interrogation regions may be built into the cell to further reduce test time of multiple samples.

A specific channel and interrogation region may be selected by a controller for use with a fluid with viscosity exceeding 2 cp, or may be selected by the system as a function of viscosity. The channel associated with an interrogation region may not be the same as other channels in the fluid cell but may have different channel physical dimensions. The channels may have different hydraulic resistances as result of their different dimensions (e.g. length, width, or depth) and the fluid may be directed into a channel based in its viscosity. In this manner, a constant pressure may be used to push a fluid into one or more channels, the channel or channels selected based fluid viscosity and channel hydraulic resistance to achieve a target fluid velocity and MMS fluidic modulation rate in the interrogation region.

These techniques may be applied in dual beam spectroscopy cell configurations.

Summary

Thus in one aspect a method is disclosed of measuring an analyte in a fluid with an analyzer, where the method includes:
performing a first spectroscopic characterization including (i) directing a first set of one or more wavelengths to an interrogation region of the fluid, (ii) changing an environmental condition of the analyte, (iii) measuring a first optical characteristic of the analyte bearing fluid, and (iv) calculating a first physical characteristic of the analyte from the first optical characteristic;
analyzing the first physical characteristic to select a second set of one more wavelengths for a second spectroscopic characterization, at least one wavelength in the second set being different than in the first set; and
performing the second spectroscopic characterization including (i) directing the second set of wavelengths to the interrogation region of the fluid, (ii) measuring a second optical characteristic of the analyte bearing fluid, and (iii) calculating a second physical characteristic of the analyte from the second optical characteristic.

The analyte may be a protein and the first physical characteristic of the analyte is a protein structural motif and the second physical characteristic of the analyte is a second protein structural motif. The environmental condition may be one or more of temperature, optical illumination, fluid properties, vibration or flow rate in a channel.

In another aspect, a fluid analyzer is disclosed that includes:
an optical source and an optical transducer defining a beam path of an optical beam;
a fluid flow cell with a fluid channel, wherein the beam path defines an interrogation region in the fluid channel in which the optical beam interacts with a fluid bearing an analyte;
a fluid modulator for changing a characteristic of the fluid between a first time interval and a second time interval at the interrogation region; and
a controller,
wherein the optical transducer is configured and operative to sample the optical beam after the optical beam interacts with the fluid in the interrogation region and generates transducer output signals,
and wherein the controller is configured and operative to (1) control the fluid modulator, (2) measure the transducer output signals from the optical transducer during the first and second time intervals, and (3) determine from the transducer output signals a measurement value indicative of a physical property of the analyte.

The fluid modulator may be a source of an electromagnetic field, electrical field, or optical illumination, and the characteristic of the fluid may be analyte concentration. The analyte may be one or more particles not dissolved in the fluid. The fluid may flow through the fluid channel during the first and second intervals. The controller may modulate the fluid flow in the fluid cell, and may synchronize the operation of the fluid flow modulation and the fluid modulator modulation. The fluid flow in the cell may be a serial or parallel streaming, as performed in an MMS analyzer.

In another aspect, a fluid analyzer is disclosed that includes:
an optical source and an optical transducer defining a beam path of an optical beam;
a fluid flow cell with a fluid channel, wherein the beam path defines an interrogation region in the fluid channel in which the optical beam interacts with fluids and resulting in transducer output signals; and
a controller configured and operative to control operation of the fluid analyzer to (1) combine a third fluid with the first or second fluid to create combined first and second fluids respectively, (2) conduct the combined first fluid and combined second fluid through the interrogation region in a first interval and a second interval respectively, (3) measure the transducer output signals from the optical transducer during the first and second time intervals when the combined first fluid and combined second fluid reside in the fluid channel, and (4) determine from the transducer output signals measurement values of the combined first and second fluids and an indication of a physical property of the first fluid or second fluids or the combined first and second fluids.

The controller may determine from the transducer output signals an amount of the third fluid to combine with the first or second fluid for subsequent determination of a second indication of the physical property of the first fluid. The combined first fluid and second fluids in the interrogation region may be substantively the same chemical formulation except for the presence of the analyte. The combined first fluid and second fluid may simultaneously flow through the channel containing the interrogation region during the first and second time intervals. The first fluid and second fluid may be substantively the same prior to combining with the third fluid. The first fluid may contain an analyte and the physical property of the first fluid may be a physical property of the analyte. The first fluid may be a diluted first fluid from a prior determination of an indication of a physical property of the first fluid. The third fluid may contain an analyte, and the concentration of the analyte in the third fluid may change over time. In another embodiment, the only the first fluid or second fluid may be combined with the third fluid. The analyzer and controller may be configured to vary the mixing time of the combined first fluid and combined second fluid (i.e. by having different wait times in their respective fluidic mixers 56 or various lines and channels between mixer and interrogation regions), and the analyzer may measure differences in the combined first and second fluids that result from a difference in wait or mix times. The fluid analyzer controller may be configured to vary the individually the time the combined first fluid and combined second fluid are present in the analyzer prior to entering the interrogation region, and determine a variation in the physical property as a function of combination time. The combination time may be the same or different for the first and second fluids.

In another aspect a fluid analyzer is disclosed that includes:
an optical source and an optical transducer defining a beam path of an optical beam;
a fluid flow cell with a fluid channel, wherein the beam path defines an interrogation region in the fluid channel in which the optical beam interacts with a first fluid containing an analyte and a second fluid, resulting in transducer output signals; and
a controller configured and operative to control operation of the fluid analyzer to (1) change a temperature of the first fluid from a first temperature to a second temperature, (2) conduct the first fluid and second fluid through the interrogation region in first and second intervals respectively, (3) measure the transducer output signals from the optical transducer during the first and second time intervals when the first fluid and second fluid reside in the fluid channel, and (4) determine from the transducer output signals measurement values of the first and second fluids and an indication of a physical property of the analyte.

The controller may determine from the transducer output signals the temperature of the first or second fluid for subsequent determination of a second indication of the physical property of the analyte. The fluid flow cell may contain regions of higher and lower thermal conductivity, the region of lower thermal conductivity containing the first fluid. The controller may continuously ramp the temperature of the first fluid and determine a sequence of indications of the analyte physical property each at a different first sample temperature. The controller may tune the optical beam to an optical wavelength for each indication in the sequence of indications of the analyte physical property. The controller may tune the optical beam to a sequence of repeating wavelengths, the first fluid sample temperature difference between each of the sequences of repeating wavelengths being substantially the same. The controller may determine from the transducer output signals the optical wavelength of the optical beam for subsequent determination of a second indication of the physical property of the analyte.

In another aspect a liquid chromatography detector is disclosed that includes:
a column output generating a first fluid containing an analyte in a first time slot;
an optical source and an optical transducer defining a beam path of an optical beam;
a fluid flow cell with a fluid channel, wherein the beam path defines an interrogation region in the fluid channel in which the optical beam interacts with the first fluid and a second fluid resulting in transducer output signals, the second fluid substantially representative of the first fluid without the analyte, the second fluid generated in a second time slot; and
a controller configured and operative to (1) conduct the first fluid and second fluid through the interrogation region in first and second time intervals respectively, (2) measure the transducer output signals from the optical transducer during the first and second time intervals when the first fluid and second fluid reside in the fluid channel, and (3) determine from the transducer output signals a physical property of the analyte.

The separation in time of the first and second time slots may be greater than the separation in time of the first and second interval. In one embodiment, the interrogation region is a first interrogation region, and the fluid flow cell contains a second fluid channel and a second interrogation region in which the fluids interact with a second optical beam resulting in transducer output signal; and the controller is configured and operative to conduct the first or second fluid to arrive at the second interrogation region at a later point in time than the first or second fluid arrives at the first interrogation region. The concentration of the analyte in the first fluid may increase and decrease over time, and the first and second time slots selected to provide the substantive maximum concentration of analyte in the first fluid and the substantive minimum concentration of analyte in the second fluid (or such other selection of time slots that improves the sensitivity of the analyzer). The first time slot may occur later in time than the second time slot, and the first time interval may occur later in time than the second time interval. The first or second fluid may be taken from the column output or a source other than the column output. In another embodiment, the second fluid may not be representative of the first fluid without the analyte but may be selected from the column output to provide two fluids for differential measurement in the analyzer and to determine a difference in a physical characteristic between the fluids. In another embodiment, a third fluid from the column output in a third time slot may be measured in a third interval, and the output signals from the first, second and third intervals and determine physical property of the fluids or analyte. The second and third output signals may be combined to improve the sensitivity of the physical property measurement relative to use of the second or third fluid alone. The time period between the first time slot and first time interval may be varied by the controller, and in one embodiment, a queue of measurement samples may be created to allow for a controller measurement time that is slower than the rate at which a series of samples are generated at the column output.

In another aspect, a method of measuring a property of a fluid includes:
defining a beam path with an optical source and an optical transducer;
defining an interrogation region in the fluid channel of a fluid flow cell, wherein the beam path interacts with fluids to generate optical signals measured by the optical transducer;
creating adjacent spatial regions of a first fluid, a separation fluid and a second fluid in a flow path connected to the fluid channel;
conducting the first fluid, the separation fluid and the second fluid through the interrogation region such that the interrogation region contains predominately the first fluid in a first time interval and primarily the second fluid in a second time interval;
creating a first and second interrogation signal from the interaction of the optical source signal, the first fluid and the second fluid within the interrogation region;
measuring the first and second interrogation signal with the optical transducer in the first and second time interval respectively; and
processing the first and second interrogation signal to determine a first property of the first fluid or a second property of the second fluid.

The separation fluid may be a gas, a fluid, a gas bubble or an immiscible fluid; it may be optically transparent to the light source; it may be chemically inert or it may have certain physical properties including performing as a clean fluid or selected to interact with the first or second fluid. The may include introducing the separation fluid into the fluid channel with a vacuum, syringe, valve or at the junction of fluidic channels. The method may include creating a third interrogation signal from the interaction of the optical signal and the separation fluid, measurement of the third interrogation signal with the optical transducer in a third interval, and using the third interrogation signal to determine an operation condition of the analyzer or the first property. The separation fluid may provide a high contrast interrogation signal relative the first or second fluid, and the method may include using the third interrogation signal to determine when a boundary region between fluids passes through the interrogation region. The method may further include measuring the boundary region with a second transducer. The method may further include changing the power of the optical source during a third interval when the separation fluid is in the interrogation region. The separation fluid may be a bubble. The method may further include adjusting the amount of separation fluid to reduce the contribution of the first fluid to the second interrogation signal. The flow path may be at least partially comprised of the fluidic channel of the flow cell. The method may include measuring a third interrogation signal with the optical transducer when a boundary region between the separation region and then first and second fluid is in the interrogation region or conducted through the interrogation region, and using the third interrogation signal to determine an operating condition of the analyzer.

In another aspect, a method of operating a fluid analyzer includes:
conducting a first fluid into a first region and a second fluid containing an analyte into a second region of a fluid flow cell of the fluid analyzer;
illuminating a location within the first region and a transducer with an optical source to define a first interrogation region wherein the first fluid interacts with light from the optical source, the transducer producing a transducer first output signal;
illuminating a location within the second region and the transducer with an optical source to define a second interrogation region wherein the second fluid interacts with light from the optical source, the transducer producing a transducer second output signal;
conducting the second fluid into the first region and illuminating a location within the first region to produce a transducer third output signal; and
determining from the first, second and third output signals a physical characteristic of the analyte.

The method may further includes conducting the first fluid into the second region and illuminating the second region to produce a transducer fourth output signal. The flows of the second fluid into the first region and the first fluid into the second region may be nominally synchronous in time. The fluid flows into the first and second regions may be nominally synchronous in time, or the fluid flows into the first and second regions may occur out of phase with respect to one another in time. The method may include stopping the flow of the first or second fluid during a time interval for generating the first or second output signals. The first and second fluids may be simultaneously conducted into the first region. The method may include performing MMS serial or parallel streaming of first and second fluids during a first time interval in the first or second region.

In another aspect, a method for determining the apparent specific volume of an analyte in a first fluid with an analyzer includes:
determining the analyte concentration in the first fluid;
measuring the optical transmission through the first fluid;
measuring the optical transmission through a second fluid, the second fluid being nominally the same as the first fluid without the analyte;
determining differential absorbance between the first fluid and the second fluid;
determining differential absorbance between the second fluid and a known standard with known spectral absorbance profile;
determining absolute absorbance of the second fluid;
determining absolute absorbance of the analyte by subtracting a fitted fractional contribution of the second fluid from the first fluid; and
determining apparent specific volume of the analyte from the fitted fractional contribution value.

The measurement of the optical transmission of the first and second fluids may be accomplished using a spectroscopic instrument, which may be based on one or more of FTIR, diffraction-based, discrete wavelength tool utilizing a tunable laser or laser array, UV absorbance, UV-CD, or Raman technologies. The fitted fractional contribution of the second fluid may be determined by varying the apparent specific volume of the analyte to achieve spectral fit between the calculated absolute absorbance spectrum of the analyte and a known reference spectrum. The known reference spectrum may be for the same analyte, or a closely related one. The spectral fit may be performed on a limited part or parts of the entire available spectrum. The fitted fractional contribution value may be determined by fitting the apparent specific volume, and the analyte concentration.

While the techniques and embodiments disclosed herein use examples such as proteins, protein buffers and water, other analytes and fluids may also be used. Various combinations of the embodiments and methods described herein may be used in other embodiments containing one or more elements of each of the underlying embodiments. It will be understood by those skilled in the art that various changes in form and details may be made without departing from the scope of the invention as defined by the appended claims.

What is claimed is:

1. A fluid analyzer, comprising:
an optical source and an optical transducer defining a beam path of an optical beam;
a fluid flow cell with a fluid channel, wherein the beam path defines an interrogation region in the fluid channel in which the optical beam interacts with a fluid bearing an analyte;
an electromagnetic fluid modulator for changing a characteristic of the fluid between a first time interval and a second time interval at the interrogation region; and
a controller,
wherein the optical transducer is configured and operative to sample the optical beam after the optical beam interacts with the fluid in the interrogation region and generates transducer output signals,
and wherein the controller is configured and operative to (1) control the fluid modulator, (2) measure the transducer output signals from the optical transducer during the first and second time intervals, and (3) determine from the transducer output signals a measurement value indicative of a physical property of the analyte.

2. The fluid analyzer of claim 1, wherein the electromagnetic fluid modulator is a source of an electric field and the characteristic of the fluid is analyte concentration.

3. The fluid analyzer of claim 1, wherein controller modulates the fluid flow in the fluid channel, and synchronizes the fluid flow modulation and electromagnetic fluid modulating.

4. The fluid analyzer of claim 1, wherein fluid flows through the fluid channel during the first and second intervals.

5. A fluid analyzer, comprising:
an optical source and an optical transducer defining a beam path of an optical beam;
a fluid flow cell with a fluid channel, wherein the beam path defines an interrogation region in the fluid channel in which the optical beam interacts with first and second fluids and resulting in transducer output signals; and
a controller configured and operative to control operation of the fluid analyzer to (1) combine a third fluid with the first or second fluid, (2) conduct the first fluid and second fluid through the interrogation region in a first interval and a second interval respectively, (3) measure the transducer output signals from the optical transducer during the first and second time intervals when the first fluid and second fluid reside in the fluid channel, and (4) determine from the transducer output signals measurement values of the first and second fluids and an indication of a physical property of the first fluid.

6. The fluid analyzer of claim 5, wherein the controller determines from the transducer output signals an amount of the third fluid to combine with the first or second fluid for subsequent determination of a second indication of the physical property of the first fluid.

7. The fluid analyzer of claim 5, wherein the first fluid and second fluid in the interrogation region are substantively the same chemical formulation except for the presence of the analyte.

8. The fluid analyzer of claim 5, wherein the first fluid and second fluid simultaneously flow through the channel containing the interrogation region during the first and second time intervals.

9. The fluid analyzer of claim 5, wherein the first fluid and second fluid are substantively the same prior to combining with the third fluid.

10. The fluid analyzer of claim 5, wherein the controller is configured to vary individually the time the combined first fluid and combined second fluid are present in the analyzer, and determine a variation in the physical property as a function of the combination time.

11. The fluid analyzer of claim 5, wherein the first fluid is a diluted first fluid from a prior determination of an indication of a physical property of the first fluid.

12. A fluid analyzer, comprising:
an optical source and an optical transducer defining a beam path of an optical beam;
a fluid flow cell with a fluid channel, wherein the beam path defines an interrogation region in the fluid channel in which the optical beam interacts with a first fluid containing an analyte and a second fluid, resulting in transducer output signals; and
a controller configured and operative to control operation of the fluid analyzer to (1) change a temperature of the first fluid from a first temperature to a second temperature, (2) conduct the first fluid and second fluid through the interrogation region in first and second intervals respectively, (3) measure the transducer output signals from the optical transducer during the first and second time intervals when the first fluid and second fluid reside in the fluid channel, and (4) determine from the transducer output signals measurement values of the first and second fluids and an indication of a physical property of the analyte.

13. The fluid analyzer of claim 12, wherein the controller determines from the transducer output signals the temperature of the first or second fluid for subsequent determination of a second indication of the physical property of the analyte.

14. The fluid analyzer of claim 12, wherein the fluid flow cell contains regions of higher and lower thermal conductivity, the region of lower thermal conductivity containing the first fluid.

15. The fluid analyzer of claim 12, wherein the controller continuously ramps the temperature of the first fluid and determines a sequence of indications of the analyte physical property each at a different first sample temperature.

16. The fluid analyzer of claim 15, wherein the controller tunes the optical beam to an optical wavelength for each indication in the sequence of indications of the analyte physical property.

17. The fluid analyzer of claim 16, wherein the controller tunes the optical beam to a sequence of repeating wavelengths, the first fluid sample temperature difference between each of the sequences of repeating wavelengths being substantially the same.

18. The fluid analyzer of claim 12, wherein the controller determines from the transducer output signals the optical wavelength of the optical beam for subsequent determination of a second indication of the physical property of the analyte.

19. A liquid chromatography detector, comprising:
a column output generating a first fluid containing an analyte in a first time slot;
an optical source and an optical transducer defining a beam path of an optical beam;
a fluid flow cell with a fluid channel, wherein the beam path defines an interrogation region in the fluid channel in which the optical beam interacts with the first fluid and a second fluid resulting in transducer output signals, the second fluid substantially representative of the first fluid without the analyte, the second fluid generated in a second time slot; and
a controller configured and operative to (1) conduct the first fluid and second fluid through the interrogation region in first and second time intervals respectively, (2) measure the transducer output signals from the optical transducer during the first and second time intervals when the first fluid and second fluid reside in the fluid channel, and (3) determine from the transducer output signals a physical property of the analyte.

20. The liquid chromatography detector of claim 19, wherein the separation in time of the first and second time slots is greater than the separation in time of the first and second interval.

21. The liquid chromatography detector of claim 19, wherein:
the interrogation region is a first interrogation region;
the fluid flow cell contains a second fluid channel and a second interrogation region in which the fluids interact with a second optical beam resulting in transducer output signals; and
the controller is configured and operative to conduct the first or second fluid to arrive at the second interrogation region at a later point in time than the first or second fluid arrives at the first interrogation region.

22. The liquid chromatography detector of claim 19, wherein the concentration of the analyte in the first fluid increases and decreases over time, and the first and second time slots are selected to provide the maximum concentration of analyte in the first fluid and the minimum concentration of analyte in the second fluid.

23. The liquid chromatography detector of claim 19, wherein the first time slot occurs later in time than the second time slot.

24. The liquid chromatography detector of claim 23, wherein the first time interval occurs later in time than the second time interval.

25. A method of measuring a property of a fluid, comprising:
defining a beam path with an optical source and an optical transducer;
defining an interrogation region in the fluid channel of a fluid flow cell, wherein the beam path interacts with fluids to generate optical signals measured by the optical transducer;
creating sequential adjacent spatial regions of a first fluid, a separation fluid and a second fluid in a flow path connected to the fluid channel;
conducting the first fluid, the separation fluid and the second fluid through the interrogation region such that the interrogation region contains predominately the first fluid in a first time interval and primarily the second fluid in a second time interval;
measuring a first and second interrogation signals with the optical transducer in the first and second time interval respectively; and
processing the first and second interrogation signals to determine a first property of the first fluid or a second property of the second fluid.

26. The method of claim 25, wherein the separation fluid is a gas or an immiscible fluid.

27. The method of claim 25, further comprising measuring a third interrogation signal with the optical transducer when a boundary region between the separation region and then first and second fluid is conducted through the interrogation region, and using the third interrogation signal to determine an operating condition of the analyzer.

28. The method of claim 27, comprised of reducing the power of the optical source during a third interval when the separation fluid is in the interrogation region.

29. The method of claim 25, wherein the separation fluid is a gas bubble.

30. The method of claim 25, further comprising adjusting the amount of separation fluid to reduce the contribution of the first fluid to the second interrogation signal.
